(19) United States
(12) Patent Application Publication
(10) Pub. No.: US 2010/0056054 A1
(43) Pub. Date: Mar. 4, 2010

(54) METHOD OF SETTING WIRELESS LINK, WIRELESS COMMUNICATION DEVICE AND WIRELESS SYSTEM

(75) Inventors: Katsumi Yamato, Chiba (JP); Takafumi Sakamoto, Tokyo (JP); Toshiyuki Umeda, Tokyo (JP); Shoji Otaka, Kanagawa (JP); Keisuke Mera, Kanagawa (JP); Hiroshi Nishimura, Tokyo (JP); Hiroo Makari, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/543,138

(22) Filed: Aug. 18, 2009

(30) Foreign Application Priority Data
Sep. 2, 2008 (JP) 2008-224784
Apr. 13, 2009 (JP) 2009-097352

(51) Int. Cl. H04B 7/00

(52) U.S. Cl. 455/41.2

(57) ABSTRACT

A method of setting a wireless link is provided between a first wireless device and a second wireless device in a wireless system. The first wireless device includes an extremely low-power receiver. When the extremely low-power receiver receives a predetermined wireless signal, the receiver turns on the first wireless device, and continues broadcast transmission of a packet periodically without a transmission pause until receiving a response packet from the second wireless device.

### CROSS-REFERENCE TO RELATED APPLICATIONS

This application is based upon and claims the benefit of priority from the prior Japanese Patent Application No. 2008-224784 filed in Japan on Sep. 2, 2008 and Japanese Patent Application No. 2009-097352 filed in Japan on Apr. 13, 2009; the entire contents of which are incorporated herein by reference.

### BACKGROUND OF THE INVENTION

1. Field of the Invention

The present invention relates to a method of setting a wireless link, a wireless communication device and a wireless system for manipulation of a manipulation target apparatus such as a TV receiver by a remote controller via Bluetooth(R) communication or Bluetooth(R) ULP communication.

2. Description of Related Art

Traditionally, a remote controller system was proposed that used wireless technology as in Japanese Patent Application Laid-Open Publication No. 10-276480, for example. In particular, this patent document discloses that a remote controller mode as well as a speech mode is prepared for a mobile phone, so that various wireless apparatuses can be remotely manipulated using a remote controller signal being wirelessly sent out from the mobile phone in the remote controller mode.

In recent years, a system is used with a short-range wireless communication technique referred to as Bluetooth (hereinafter, Bluetooth(R)).

The Bluetooth(R) is operational in a 2.4 GHz wide band (2402 to 2480 MHz). The Bluetooth(R) has advantages such as: communication by switching between channels for 1,600 times per second can reduce influence of a nearby interfering wireless apparatus as much as possible; security functions are prepared such as 128-bit encryption and PIN code authentication; communication is not prevented by shielding because of non-directivity; and audio data can be sent.

Nowadays, Ultra Low Power Bluetooth(R) (abbreviated as ULP Bluetooth(R)) is under development and under specification planning. The ULP Bluetooth(R) is a technique specialized for communication of small-sized data. By introducing a technique for a longer transmission pause, it is expected to realize lower power consumption than the Bluetooth(R).

To establish CONNECTION setting between two wireless apparatuses in the ULP Bluetooth(R) communication technique, one wireless apparatus performs operation referred to as an advertiser, while the other wireless apparatus performs operation referred to as an initiator.

The operation referred to as an advertiser is operation to permit a wireless connection request by the other wireless apparatus. In this operation, an advertiser periodically sends broadcast packets referred to as ADV_IND packets, and waits to receive response packets to the broadcast packets from an initiator.

On the other hand, the operation referred to as an initiator is operation by a wireless apparatus to request wireless connection. In that operation, when an initiator can receive an ADV_IND packet transmitted from an advertiser, it sends a response packet referred to as a CONNECT_REQ packet.

If the advertiser can receive the CONNECT_REQ packet transmitted from the initiator, CONNECTION setting by ULP Bluetooth(R) communication is established between the wireless apparatus operating as an advertiser and the wireless apparatus operating as an initiator, that is, a so-called link is established.

However, there are problems in processing CONNECTION setting by the ULP Bluetooth(R) communication technique, as described below.

An advertiser side must continue to transmit ADV_IND packets until receiving a CONNECT_REQ packet transmitted from an initiator. Therefore, the advertiser side that continues to transmit the ADV_IND packets requires much power consumption.

Meanwhile, if the transmission interval of consecutive ADV_IND packets becomes larger so that the number of transmissions is decreased for an ADV_IND packet to reduce power consumption on the advertiser side, the initiator side needs a longer time to receive an ADV_IND packet. The initiator side cannot transmit a CONNECT_REQ packet unless receiving an ADV_IND packet. Therefore, it takes a longer time for connection, i.e., link formation, impairing immediacy (responsiveness).

### BRIEF SUMMARY OF THE INVENTION

One aspect of the present invention is a wireless system between a first wireless device and a second wireless device, wherein: the first wireless device includes a first wireless module having an extremely low-power reception function of receiving an activation indication from the second wireless device and turning on at least the first wireless device based on the indication, and a second wireless module to continue broadcast transmission of a packet periodically without a transmission pause until receiving a response packet from the second wireless device and to establish a link to the second wireless device; and the second wireless device includes an operation indication detection section configured to detect an operation indication from outside and to send out an activation indication and a CONNECTION setting request, a third wireless module configured to accept the activation indication from the operation indication detection section and to send out an activation indication message to the first wireless module of the first wireless device, and a fourth wireless module configured to accept the CONNECTION setting request from the operation indication detection section, to wait to receive the packet in the broadcast transmission, and to transmit the response packet to the second wireless module of the first wireless device when receiving the packet in the broadcast transmission.

Another aspect of the present invention is a wireless communication device including: a first wireless module having an extremely low-power reception function of receiving an activation indication from an external wireless device, and turning on at least the wireless device based on the indication; and a second wireless module to continue broadcast transmission of a packet periodically without a transmission pause until receiving a response packet from the external wireless device, and to establish a link to the external wireless device.

Another aspect of the present invention is a wireless communication device including: an operation indication detection section configured to detect an operation indication from outside and send out an activation indication and a CONNECTION setting request; a third wireless module configured to accept the activation indication from the operation indication detection section and send out an activation indication message to a first wireless module of a first wireless device differing from the wireless communication device; and a fourth wireless module configured to accept the CONNECTION setting request from the operation indication detection section, wait to receive the packet in the broadcast transmission, and transmit the response packet to a second wireless module of the first wireless device when receiving the packet in the broadcast transmission.

Another aspect of the present invention is a method of setting a wireless link in a wireless system between a first wireless device and a second wireless device, wherein: the first wireless device including an extremely low-power receiver turns on the first wireless device and continues broadcast transmission of a packet periodically without a transmission pause until reception of a response packet from the second wireless device when the extremely low-power receiver receives a predetermined wireless signal.

Another aspect of the present invention is a method of setting a wireless link between a first wireless device and a second wireless device in a wireless system, wherein: the first wireless device being equipped with an extremely low-power receiver turns on the first wireless device and enters operation to wait for a packet transmitted from the second wireless device when the extremely low-power receiver receives a predetermined wireless signal.

### BRIEF DESCRIPTION OF THE DRAWINGS

FIG. 1 is a block diagram schematically showing a wireless system according to a first embodiment of the present invention;

FIG. 2 is a block diagram showing one configuration example of a remote controller as a second wireless device in FIG. 1;

FIG. 3 is a block diagram showing another configuration example of the remote controller as the second wireless device in FIG. 1;

FIG. 4 is a block diagram showing a configuration example of a manipulation target apparatus as a first wireless device in FIG. 1;

FIG. 5 is a diagram illustrating configuration and operation of a rectifier in the manipulation target apparatus in FIG. 4;

FIG. 6 is a diagram showing a processing flow until communication is initiated with a ULP Bluetooth(R) link being established between the remote controller as the second wireless device and the manipulation target apparatus as the first wireless device;

FIG. 7 is a flowchart illustrating operation by a remote controller side in the processing shown in FIG. 6;

FIG. 8 is a flowchart illustrating operation by a manipulation target apparatus side in the processing shown in FIG. 6;

FIG. 9 is a block diagram schematically showing a wireless system according to a second embodiment of the present invention;

FIG. 10 is a block diagram showing one configuration example of a remote controller as a second wireless device in FIG. 9;

FIG. 11 is a block diagram showing another configuration example of the remote controller as the second wireless device in FIG. 9;

FIG. 12 is a block diagram showing a configuration example of a manipulation target apparatus as a first wireless device in FIG. 9;

FIG. 13 is a diagram showing one example of a processing flow until communication is initiated with a Bluetooth(R) link being established between the second wireless device and the first wireless device;

FIG. 14 is a diagram showing another example of the processing flow until communication is initiated with a Bluetooth(R) link being established between the second wireless device and the first wireless device;

FIG. 15 is a block diagram schematically showing a wireless system according to a third embodiment of the present invention;

FIG. 16 is a block diagram schematically showing a wireless system according to a fourth embodiment of the present invention;

FIG. 17 is a block diagram showing one configuration example of a remote controller as a second wireless device in FIG. 16;

FIG. 18 is a block diagram showing another configuration example of the remote controller as the second wireless device in FIG. 16;

FIG. 19 is a block diagram showing a configuration example of a manipulation target apparatus as a first wireless device in FIG. 16;

FIG. 20 is a diagram showing a processing flow of collection of manipulation target apparatus information by ULP Bluetooth(R) communication between a fourth wireless module being activated by notification of a common ID from a second wireless device and a second wireless module;

FIG. 21 is a flowchart illustrating operation by a remote controller side in the processing shown in FIG. 20;

FIG. 22 is a flowchart illustrating operation by a manipulation target apparatus side in the processing shown in FIG. 20;

FIG. 23 is a diagram showing a processing flow until communication is initiated with a ULP Bluetooth(R) link being established between the second wireless device and the first wireless device;

FIG. 24 is a flowchart showing operation by the second wireless device in the processing shown in FIG. 23;

FIG. 25 is a flowchart showing operation by the first wireless device in the processing shown in FIG. 23;

FIG. 26 is a block diagram showing a wireless system according to a fifth embodiment of the present invention;

FIG. 27 is a block diagram showing configuration of an on-vehicle device in FIG. 26; and

FIG. 28 is a diagram showing an operation flow until the on-vehicle device and a mobile phone in FIG. 26 are automatically connected by Bluetooth(R).

### DETAILED DESCRIPTION OF THE INVENTION

When the present application was filed in the Japanese Patent Office, the technique specialized for communication of small-sized data had been called “ULP Bluetooth (R). However, the technique is currently called “Bluetooth (R) Low Energy”.

The following will describe embodiments of the present invention in detail with reference to the drawings.

First, an overview of the present invention will be described in the following.

In a method of setting a wireless link between wireless devices that can be connected via Ultra Low Power Bluetooth(R) communication (ULP Bluetooth(R) communication), a first wireless device is equipped with an extremely low-power receiver (sometimes referred to as ECO CHIP), and a second wireless device transmits a wireless signal to turn power of the first wireless device on to the above extremely low-power receiver, initiates operation as an initiator of ULP Bluetooth(R) communication, and waits for an ADV_IND packet (Advertising Indication packet) or an ADV_DIRECT_IND packet (Advertising Directed Indication packet) transmitted from the first wireless device. On the first wireless device side, when the above extremely low-power receiver receives a predetermined signal, the first wireless device initiates operation as an advertiser of ULP Bluetooth(R) communication, and continues to transmit ADV_IND packets or ADV_DIRECT_IND packets periodically without a transmission pause until receiving a CONNECT_REQ packet (Connection Request packet) transmitted from the second wireless device side.

### First Embodiment

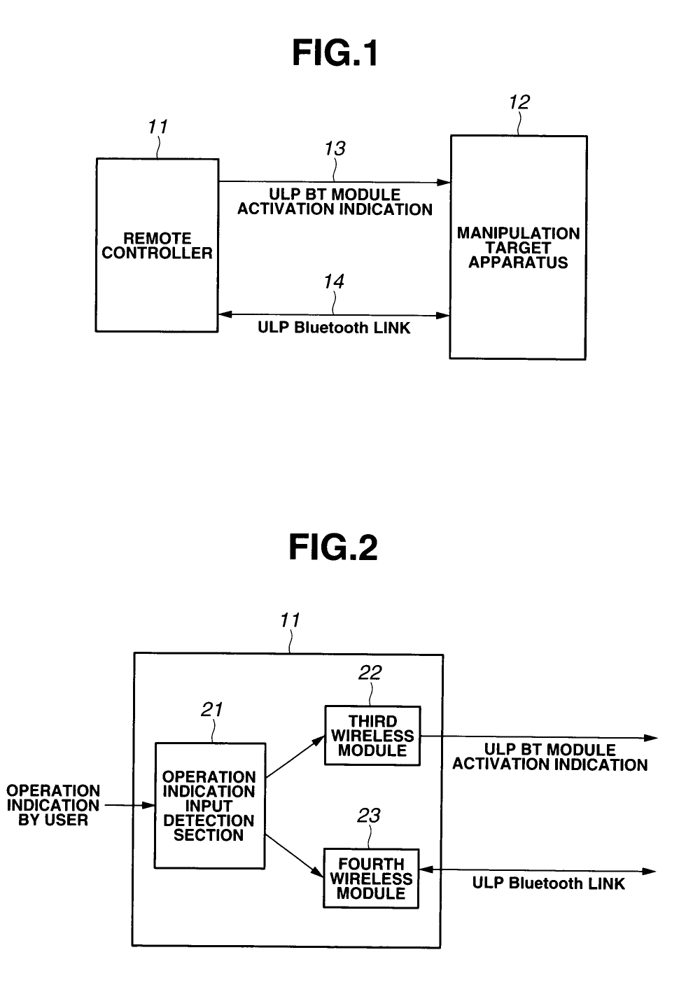

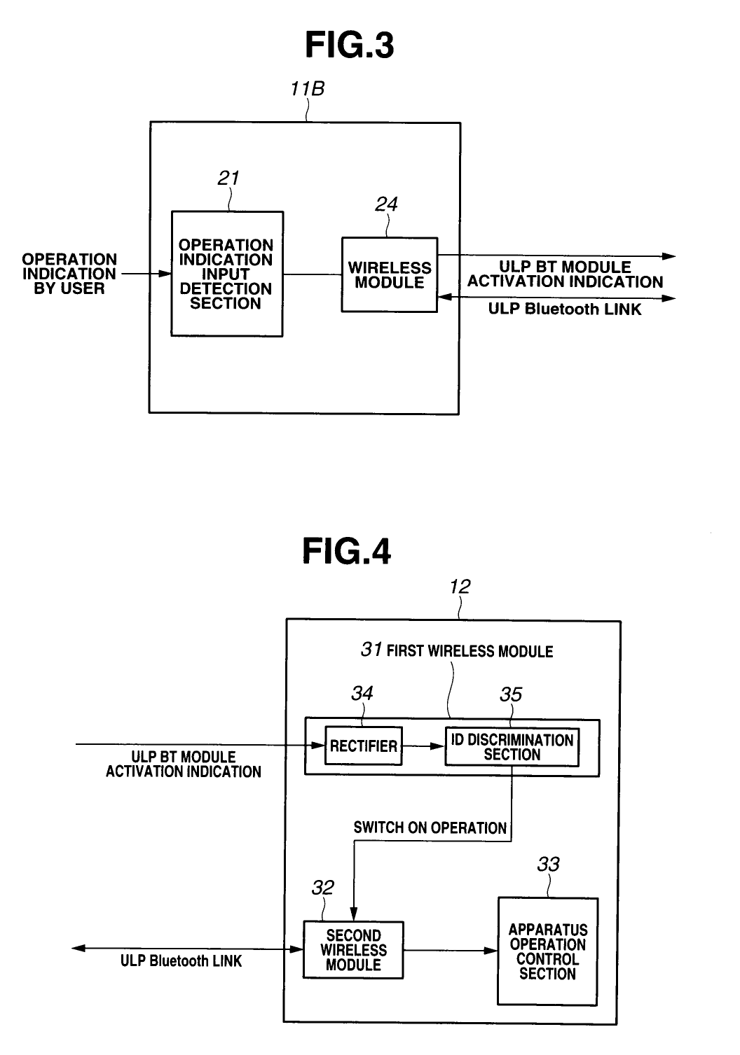

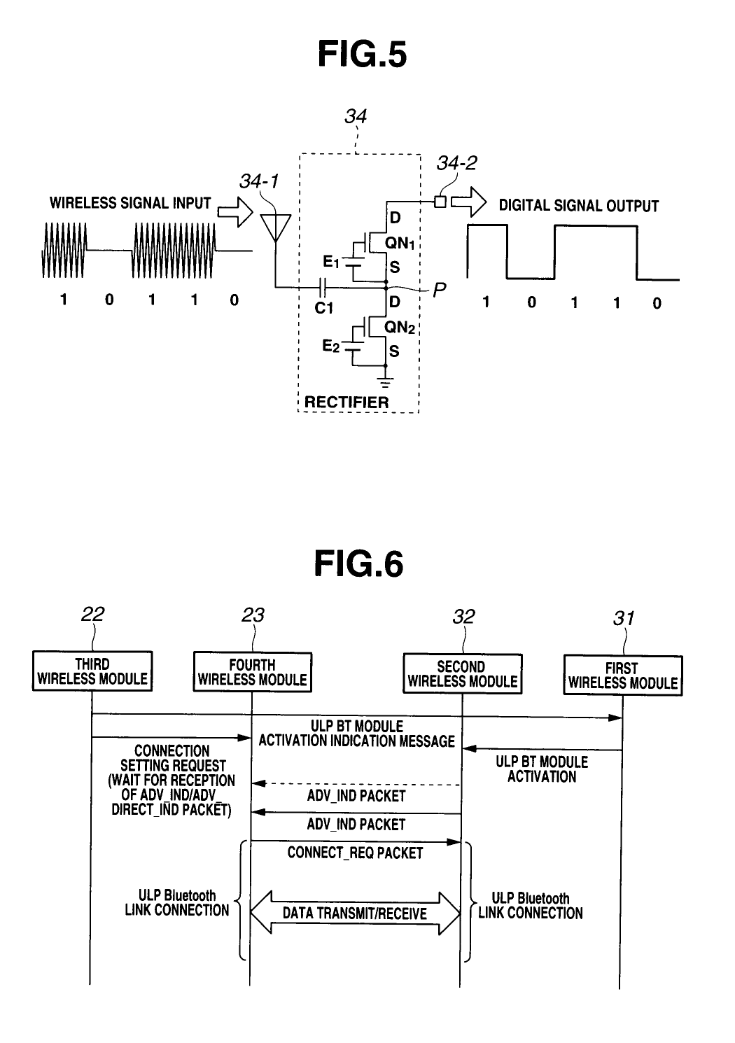

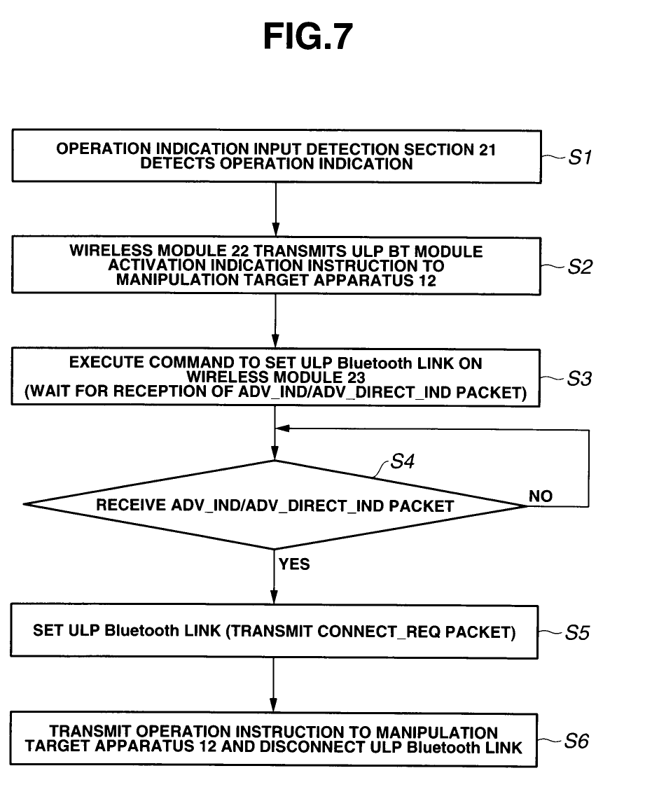

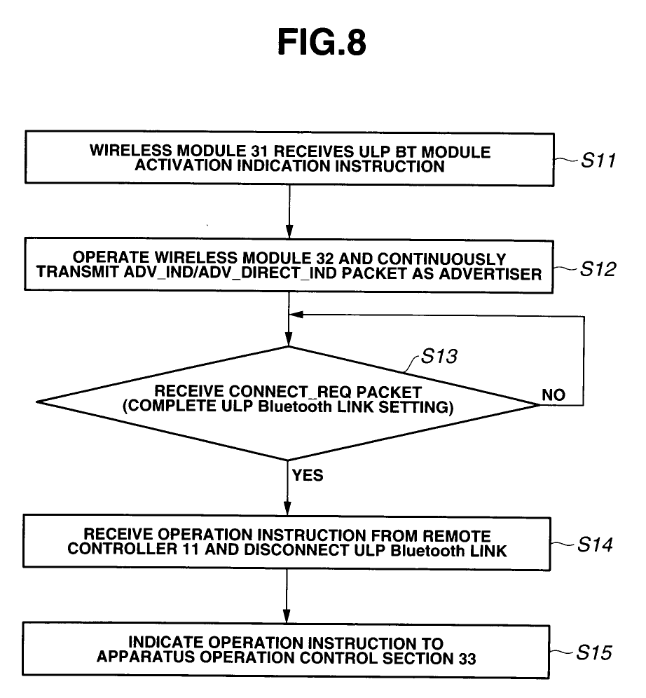

FIG. 1 is a block diagram schematically showing a wireless system according to the first embodiment of the present invention. FIG. 2 is a block diagram showing one configuration example of a remote controller as a second wireless device in FIG. 1. FIG. 3 is a block diagram showing another configuration example of the remote controller as the second wireless device in FIG. 1. FIG. 4 is a block diagram showing a configuration example of a manipulation target apparatus as a first wireless device in FIG. 1. FIG. 5 is a block diagram illustrating a configuration example of a rectifier in the manipulation target apparatus shown in FIG. 4. FIG. 6 is a diagram showing a processing flow until communication is initiated with a ULP Bluetooth(R) link being established between the second wireless device and the first wireless device. FIG. 7 is a flowchart illustrating operation by a remote controller side in the processing shown in FIG. 6. FIG. 8 is a flowchart illustrating operation by a manipulation target apparatus side in the processing shown in FIG. 6. In the first embodiment, the present invention is applied to a wireless system for ULP Bluetooth(R) communication.

The wireless system shown in the drawings is a system that automatically performs processing to set connection between a manipulation target apparatus 12 and a remote controller 11 based on an operation indication inputted from outside (a user) to the remote controller 11 between the manipulation target apparatus 12 as a first wireless device and the remote controller 11 as a second wireless device, transmits/receives necessary data such as an operation instruction soon after a link is established, then performs CONNECTION disconnection processing for termination.

The manipulation target apparatus 12 as the first wireless device includes: a first wireless module 31 including an extremely low-power receiver configured to receive an activation indication message from the remote controller 11 as the second wireless device, and output a power-on signal based on the activation indication; and a second wireless module 32 configured to operate by the power-on signal from the first wireless module 31, and continue broadcast transmission of packets periodically without a transmission pause until receiving a response packet from the remote controller 11 to establish a link for the remote controller 11.

The remote controller 11 as the second wireless device includes: an operation indication input detection section 21 being an operation indication detection section configured to detect an operation indication from outside (a user), and send out an activation indication and a CONNECTION setting request; a third wireless module configured to accept the activation indication from the operation indication input detection section 21 and send out an activation indication message to the first wireless module 31 of the manipulation target apparatus 12 being the first wireless device; and a fourth wireless module 23 configured to accept the CONNECTION setting request from the operation indication input detection section 21, wait for reception of an ADV_IND packet (Advertising Indication packet) or an ADV_DIRECT_IND packet (Advertising Directed Indication packet) for broadcast transmission, receive the ADV_IND packet (Advertising Indication packet) or the ADV_DIRECT_IND packet (Advertising Directed Indication packet) for broadcast transmission and then transmit a CONNECT_REQ packet (Connection Request packet) as a response packet to the second wireless module 32 of the manipulation target apparatus 12.

Operation of the wireless system with the above configuration will be described with reference to the drawings. A method of setting a wireless link in the wireless system will be mainly described.

The first embodiment of the present invention includes an embodiment in which the remote controller 11 is used to manipulate the manipulation target apparatus 12 such as a TV receiver, as shown in FIG. 1. In the present embodiment, the remote controller 11 establishes communication for the manipulation target apparatus 12 such as:

(1) communication to instruct activation of ULP Bluetooth(R) communication (a ULP BT module activation indication 13), and

(2) communication to transmit/receive manipulation information (communication via a ULP Bluetooth(R) link 14). A ULP Bluetooth(R) communication technique herein is a communication technique of integration of a Wibree communication technique known as a low-power consumption wireless communication technique into well-known Bluetooth(R) specifications. This technique, which is a short-range wireless communication technique using a 2.4 GHz band radio same as the Bluetooth(R) communication technique, can make a longer communication waiting time possible than the Bluetooth(R) communication technique, allowing intermittent transmission and hence lower power consumption. For the ULP Bluetooth(R) communication technique, a Bluetooth(R) SIG (Special Interest Group) is working for standardization.

FIG. 2 is a block diagram showing configuration of the remote controller 11. When the operation indication input detection section 21 accepts an operation indication to the manipulation target apparatus 12 from a user through push-down of a button of the remote controller 11 being the second wireless device or speech recognition, the section 21 instructs a third wireless module 22 to transmit the ULP BT module activation indication 13 as a predetermined wireless signal (a ULP BT module activation indication message), and instructs the fourth wireless module 23 to initiate communication via the ULP Bluetooth(R) link 14 (a CONNECTION setting request).

Detailed contents of an indication to the fourth wireless module 23 by the operation indication input detection section 21 is execution of a connection creating command (HCI_ULP_Create_LL_Connection command) determined in the ULP Bluetooth(R) communication specifications. With this command, the fourth wireless module 23 initiates operation as an initiator in the ULP Bluetooth(R) communication, and enters reception waiting operation to receive an ADV_IND packet (Advertising Indication packet) or an ADV_DIRECT_IND packet (Advertising Directed Indication packet) transmitted from an advertiser of the manipulation target apparatus 12 being the first wireless device.

A payload portion of an ADV_IND packet contains address information specifying an advertiser of a transmission source. Meanwhile, a payload portion of an ADV_DIRECT_IND packet contains, in addition to address information specifying an advertiser of a transmission source, address information specifying an initiator being a transmission destination of the packet.

In FIG. 2, it is also possible to integrate the third wireless module 22 and the fourth wireless module 23.

FIG. 3 shows a block diagram of configuration of a remote controller 11B in the above integration.

In FIG. 3, when the operation indication input detection section 21 accepts an operation indication to the manipulation target apparatus 12 from a user through push-down of a button of the remote controller 11B or speech recognition, the section 21 instructs a wireless module 24 to transmit the ULP BT module activation indication 13, and then instructs the wireless module 24 to initiate communication via the ULP Bluetooth(R) link 14. Detailed contents of an indication from the operation indication input detection section 21 to the wireless module 24 is execution of a connection creating command (HCI_ULP_Create_LL_Connection command) determined in the ULP Bluetooth(R) communication specifications. With this command, the wireless module 24 initiates operation as an initiator in the ULP Bluetooth(R) communication, and enters reception waiting operation to receive an ADV_IND packet or an ADV_DIRECT_IND packet transmitted from an advertiser including the second wireless module 32 in the manipulation target apparatus 12.

Although the remote controller can be configured as shown in FIG. 3, the following will describe a case in that the remote controller is configured as shown in FIG. 2.

FIG. 4 is a block diagram showing configuration of the manipulation target apparatus 12. The first wireless module 31 has an extremely low-power receiver (ECO CHIP) including a rectifier 34 configured to convert AC power to DC power, and an ID discrimination section 35 configured to determine whether or not a signal matches a predetermined ID, as shown in FIG. 4. When the rectifier 34 receives a wireless signal, it converts the signal to a digital signal and outputs the digital signal to the ID discrimination section 35. The ID discrimination section 35 discriminates a predetermined ID contained in the received digital signal.

The first wireless module 31 receives the ULP BT module activation indication 13. Only if the received activation indication signal matches information being previously determined with the remote controller 11, the module 31 turns operation of the second wireless module 32 to an on-state, the operation being normally in an off-state, and activates the second wireless module 32. The second wireless module 32 activated according to a predetermined procedure initiates operation as an advertiser determined in the ULP Bluetooth(R) communication specifications by an advertiser initiation indication command (HCI_ULP_Write_Advertise_Mode command) executed by the first wireless module 31. Then, the module 32 enters operation to periodically broadcast ADV_IND packets, or operation to periodically transmit ADV_DIRECT_IND packets to the fourth wireless module 23. In this operation, a command specifying contents of operation as an advertiser executed by the first wireless module 31 (HCI_ULP_Set_Advertise_Parameters command) is used to decide whether to periodically transmit ADV_IND packets or periodically transmit ADV_DIRECT_IND packets while the second wireless module 32 operates as an advertiser.

FIG. 5 shows one example of configuration and operation of the rectifier 34. The rectifier 34 has serial configuration of nMOS transistors QN1 and QN2. Voltage sources E1 and E2 configured to apply a predetermined positive bias voltage are connected between each gate and source. An RF signal being a carrier wave corresponding to a signal ‘1’ or ‘0’ is interruptedly inputted to an intermediate node P between the voltage sources from an antenna 34-1 via a capacitor C1. That is, a forward bias voltage has been previously applied to respective gates of the transistors QN1 and QN2. In this state, if a digitally modulated signal representing the signal ‘1’ or ‘0’ corresponding to presence or absence of an RF signal is inputted to the intermediate node P, as shown, output voltage (rectified voltage) is generated between a drain D of the transistor QN1 and a source S of the transistor QN2 based on an electrical potential change in a portion corresponding to the signal ‘1’ indicative of presence of the RF signal. As a result, an output terminal 34-2 outputs a digital signal in a column of ‘1’ and ‘0’ signals. The digital signal is inputted to the ID discrimination section 35.

As described in the above, a current flows into the transistors QN1 and QN2 only if an RF signal in a wireless signal as input is inputted from the antenna 34-1, realizing an ultra low-power consumption receiver.

The ID discrimination section 35 determines whether or not a digital signal outputted from the rectifier 34 matches a predetermined ID. If the signal matches the predetermined ID, the ID discrimination section 35 instructs the second wireless module 32 to be turned on. In this stage, part or whole of the manipulation target apparatus 12 can be turned on.

In the present embodiment, the operation as an advertiser by the second wireless module 32 is triggered by a ULP BT module activation indication from the remote controller 11 side being a ULP Bluetooth(R) communication partner. That is, in the present embodiment, it is ensured that the fourth wireless module 23 of the remote controller 11 side operates as an initiator and is in a reception waiting mode. Therefore, while ADV_IND packets or ADV_DIRECT_IND packets are periodically transmitted after every certain time period with consideration of low power in a conventional way, the second wireless module 32 in the present embodiment continues to transmit ADV_IND packets or ADV_DIRECT_IND packets periodically without a transmission pause. In a command to specify contents of operation as an advertiser (HCI_ULP_Set_Advertise_Parameters command), a period can be specified to transmit ADV_IND packets or ADV_DIRECT_IND packets. In the present embodiment, the command is used to set a parameter for a shortest transmission period (20 ms, in the ULP Bluetooth(R) communication specifications), enabling intermittent transmission of ADV_IND packets or ADV_DIRECT IND packets without a transmission pause.

Thus, a time can be shortened to set the ULP Bluetooth(R) link 14. As a result, a manipulation indication from the remote controller 11 arrives at the manipulation target apparatus 12 faster. That is, the remote controller 11 and the manipulation target apparatus 12 can be made to consume low power, as well as a response can be returned faster to a manipulation indication from the remote controller 11 of the manipulation target apparatus 12.

FIG. 6 shows a processing flow until initiation of communication via the ULP Bluetooth(R) link 14 between the fourth wireless module 23 and the second wireless module 32 configured to be activated as described in the above. In FIG. 6, a portion shown by a dotted line represents that it takes a time for the wireless module 23 to receive an ADV_IND packet or an ADV_DIRECT_IND packet.

FIG. 7 shows operation of the remote controller 11 side and FIG. 8 shows operation of the manipulation target apparatus 12 side both in the processing shown in FIG. 6.

In FIG. 7, the operation indication input detection section 21 detects an operation indication inputted from outside (step S1). The third wireless module 22 transmits an instruction of the ULP BT module activation indication 13 to the manipulation target apparatus 12 (step S2). Next, a command is executed to set a ULP Bluetooth(R) link on the fourth wireless module 23 (a CONNECTION setting request), and the remote controller 11 waits to receive an ADV_IND packet or an ADV_DIRECT_IND packet (step S3).

When an ADV_IND packet or an ADV_DIRECT_IND packet is received (step S4), a CONNECT_REQ packet is transmitted to set the ULP Bluetooth(R) link 14 (step S5). Next, an operation instruction to the manipulation target apparatus 12 is transmitted, and then the ULP Bluetooth(R) link is disconnected (step S6).

In FIG. 8, first, the first wireless module 31 receives the instruction of the ULP BT module activation indication 13 (step S11). The second wireless module 32 is operated, and continuously receives ADV_IND packets or ADV_DIRECT_IND packets as an advertiser (step S12).

When the CONNECT_REQ packet is received, setting of the ULP Bluetooth(R) link 14 is completed (step SI 3). After an operation instruction of the remote controller 11 is received, the ULP Bluetooth(R) link is disconnected (step S14). Next, an operation instruction is made to an apparatus operation control section 33 (step S15).

When the fourth wireless module 23 in the remote controller 11 receives an ADV_IND packet transmitted from the second wireless module 32 in the manipulation target apparatus 12, the fourth wireless module 23 transmits a CONNECT_REQ packet (Connection Request packet) as a response to the ADV_IND packet to the second wireless module 32. If the second wireless module 32 can normally receive the CONNECT_REQ packet, the ULP Bluetooth(R) link 14 is set between the fourth wireless module 23 and the second wireless module 32, i.e. between the remote controller 11 and the manipulation target apparatus 12. In this case, the fourth wireless module 23, i.e. the remote controller 11 side, is a master (connecting side), while the second wireless module 32, i.e. the manipulation target apparatus 12 side, is a slave (connected side). Until connection is set (established) between the fourth wireless module 23 and the second wireless module 32, the remote controller 11 is referred to as an initiator and the manipulation target apparatus 12 is referred to as an advertiser. After connection is set (established) between the fourth wireless module 23 and the second wireless module 32, the remote controller 11 is referred to as a master and the manipulation target apparatus 12 is referred to as a slave.

After the ULP Bluetooth(R) link 14 is set, the remote controller 11 notifies the manipulation target apparatus 12 of contents of an operation indication. The manipulation target apparatus 12, which receives the contents of operation indication, controls the apparatus so that the apparatus operation control section 33 performs desired operation. When the notification of the contents of operation indication finishes, the ULP Bluetooth(R) link 14 is disconnected.

In FIG. 6, the second wireless module 32 being an advertiser transmits an ADV_IND packet as a packet to be transmitted. However, instead of broadcasting an ADV_IND packet, a ULP Bluetooth(R) link is set, contents of an operation indication is notified, and the ULP Bluetooth(R) link is disconnected under a similar procedure even if the second wireless module 32 transmits an ADV_DIRECT_IND packet to the fourth wireless module 23.

According to the first embodiment of the present invention, a second wireless module operating as an advertiser can transmit an ADV_IND packet or an ADV_DIRECT IND packet only if a fourth wireless module being a connection partner for a ULP Bluetooth(R) link has initiated operation as an initiator, so that unnecessary ADV_IND packet or ADV_DIRECT_IND packet transmission can be prevented. As a result, power consumption of the second wireless module operating as an advertiser can be reduced. Moreover, according to the first embodiment, the second wireless module operating as an advertiser previously knows that the fourth wireless module being a connection partner has initiated the operation as an initiator, hence intermittent transmission of ADV_IND packets or ADV_DIRECT_IND packets that consumes a large amount of power in a conventional use is performed only in necessary periods, preventing consumption of a large amount of power. That is, only in periods that need CONNECTION setting based on an operation indication by a user, a ULP Bluetooth(R) link can be set instantly between the second wireless module and the fourth wireless module.

Therefore, it can be ensured that a wireless link is established in response to an operation indication such as from a user, and a method of setting a wireless link and a wireless system can be realized that reduce power consumption for the link establishment as much as possible.

### Second Embodiment

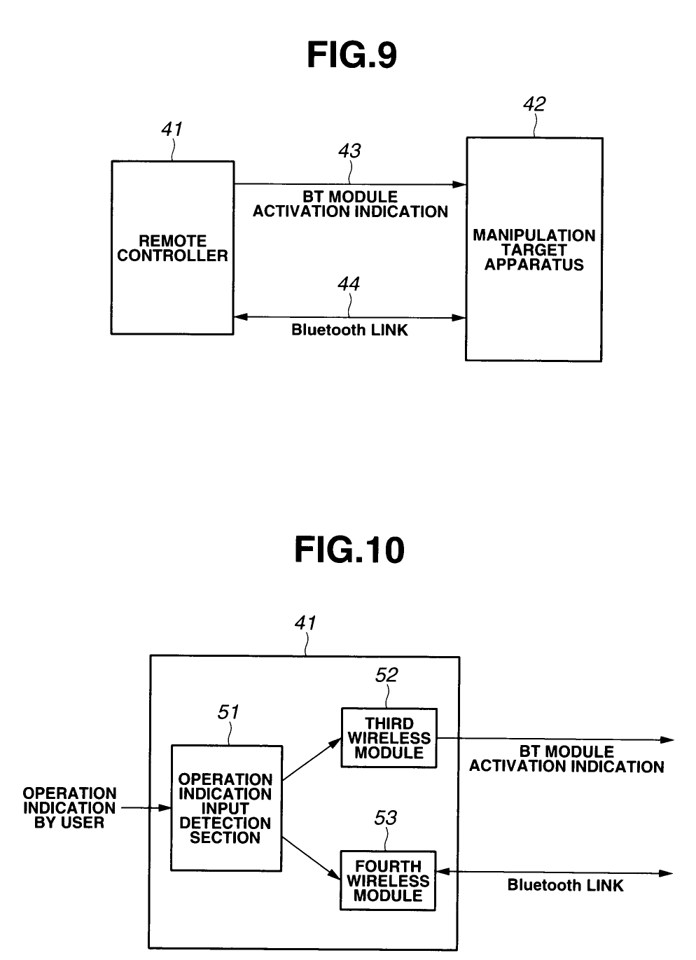

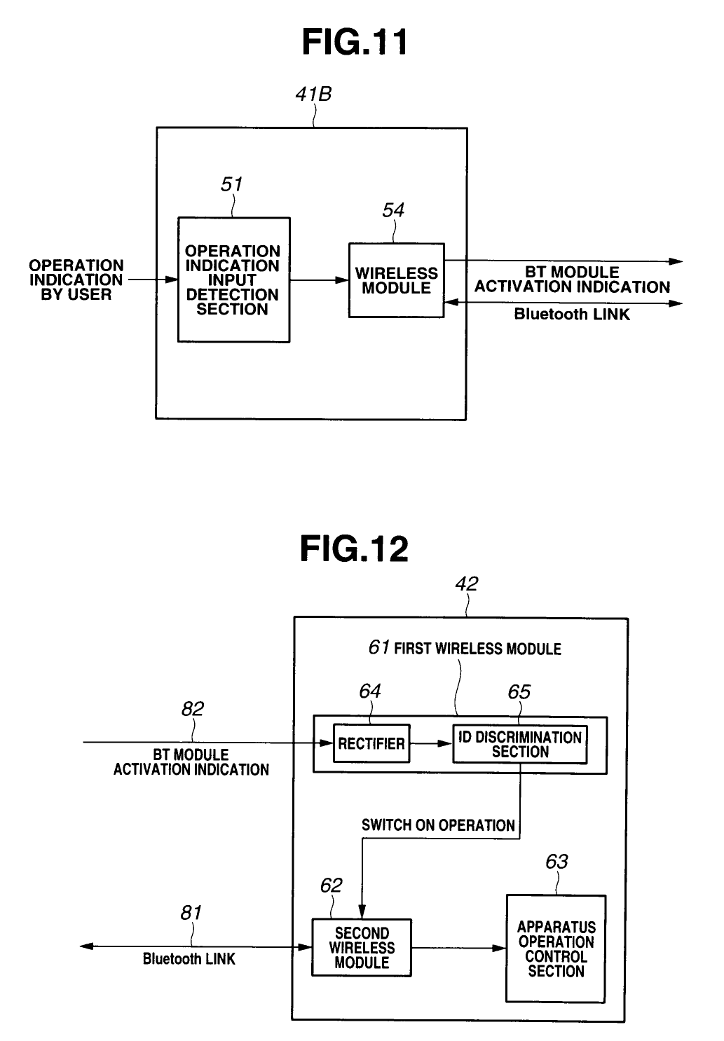

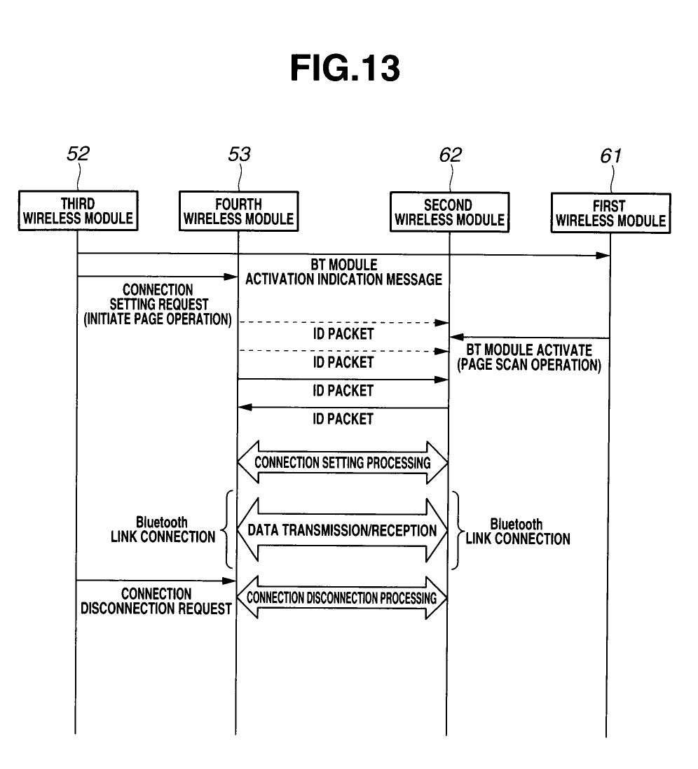

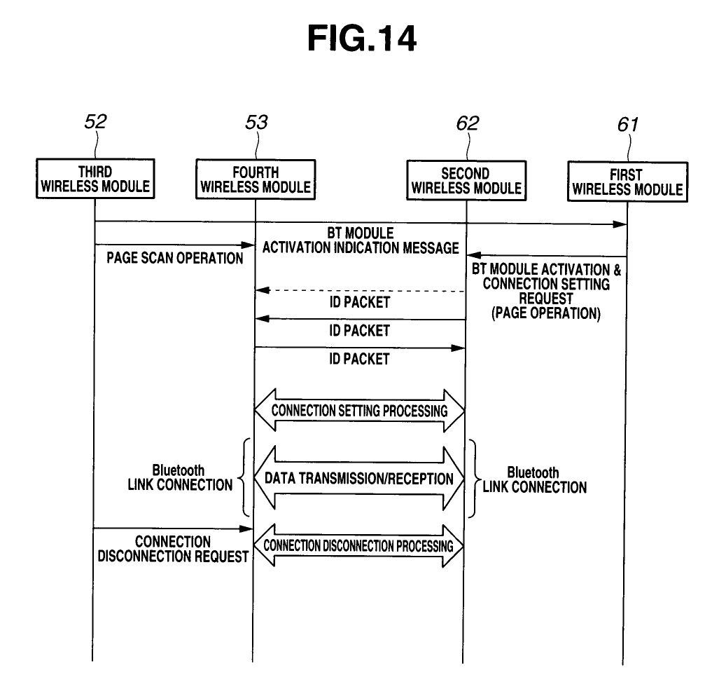

FIG. 9 is a block diagram schematically showing a wireless system according to a second embodiment of the present invention. FIG. 10 is a block diagram showing one configuration example of a remote controller as a second wireless device in FIG. 9. FIG. 11 is a block diagram showing another configuration example of the remote controller as the second wireless device in FIG. 9. FIG. 12 is a block diagram showing a configuration example of a manipulation target apparatus as a first wireless device in FIG. 9. FIG. 13 is a diagram showing one example of a processing flow until communication is initiated with a Bluetooth(R) link being established between the second wireless device and the first wireless device. FIG. 14 is a diagram showing another example of the processing flow until communication is initiated with a Bluetooth(R) link being established between the second wireless device and the first wireless device. In the second embodiment, the present invention is applied to a wireless system for ULP Bluetooth(R) communication.

The wireless system shown in the drawings performs, based on an operation indication to the second wireless device 41 from outside between a first wireless device 42 and a second wireless device 41, CONNECTION setting processing between both the wireless devices 42 and 41. As soon as a link is established, the wireless system transmits/receives necessary data such as an operation instruction, and then disconnects and finishes CONNECTION setting.

A manipulation target apparatus 42 as the first wireless device includes: a first wireless module 61 including an extremely low-power receiver configured to receive an activation indication message from a remote controller 41 as the second wireless device and output a power-on signal based on the activation indication; and a second wireless module 62 configured to operate with the power-on signal from the first wireless module 61, initiate Page Scan processing determined in the Bluetooth(R) communication specifications, enter receiving operation to receive an ID packet transmitted from the remote controller 41 to be connected according to Bluetooth(R), and perform operation to establish a link to a fourth wireless module 53 in the remote controller 41.

The remote controller 41 as the second wireless device includes: an operation indication input detection section 51 as an operation indication detection section configured to detect an operation indication from outside and send out an activation indication and a CONNECTION setting request; a third wireless module 52 configured to accept the activation indication from the operation indication input detection section 51 and send out an activation indication message to the first wireless module 61 in the manipulation target apparatus 42 being the first wireless device; and the fourth wireless module 53 configured to accept the CONNECTION setting request from the operation indication input detection section 51, initiate Page processing in Bluetooth(R) communication, enter transmitting operation to transmit an ID packet to the manipulation target apparatus 42 to be connected according to the Bluetooth(R), and perform operation to establish a link to the second wireless module 62 in the manipulation target apparatus 42.

Operation of the wireless system with the above configuration will be described with reference to the drawings. A method of setting a wireless link in the wireless system will be mainly described.

The second embodiment of the present invention includes an example in that the remote controller 41 uses the Bluetooth(R) communication technique to manipulate the manipulation target apparatus 42, as shown in FIG. 9. In the present embodiment, the remote controller 41 establishes communication for the manipulation target apparatus 42 such as:

(1) communication to instruct activation of Bluetooth(R) communication (a BT module activation indication 43), and

(2) communication to transmit/receive manipulation information (communication via a Bluetooth(R) link 44).

FIG. 10 is a block diagram showing configuration of the remote controller 41. When the operation indication input detection section 51 accepts an operation indication to the manipulation target apparatus 42 from a user through push-down of a button of the remote controller 41 or speech recognition, the section 51 instructs the third wireless module 52 to transmit the BT module activation indication 43, and instructs the fourth wireless module 53 to initiate communication via the Bluetooth(R) link 44. Detailed contents of the indication to the fourth wireless module 53 by the operation indication input detection section 51 is execution of a connection creating command determined in the Bluetooth(R) communication specifications. With this command, the fourth wireless module 53 initiates Page processing in Bluetooth(R) communication, and enters operation to transmit an ID packet to the manipulation target apparatus 42 to be connected according to Bluetooth(R).

In FIG. 10, it is also possible to integrate the first wireless module 52 and the second wireless module 53.

FIG. 11 shows a block diagram of configuration of a remote controller 41B in the above integration. When the operation indication input detection section 51 accepts an operation indication to the manipulation target apparatus 42 from a user through push-down of a button of the remote controller 41B or speech recognition, the section 51 instructs a wireless module 54 to transmit the BT module activation indication 43, and then instructs the wireless module 54 to initiate communication via the Bluetooth(R) link 44.

The following will describe a remote controller being in the configuration shown in FIG. 10, but the present embodiment is not so limited.

FIG. 12 is a block diagram showing configuration of the manipulation target apparatus 42. The first wireless module 61 receives the BT module activation indication 43. Only if the received activation indication signal matches information being previously determined with the remote controller 41, the module 61 turns operation of the second wireless module 62 to an on-state, the operation being normally in an off-state, and activates the second wireless module 62. The second wireless module 62 activated according to a predetermined procedure initiates Page Scan processing determined in the Bluetooth(R) communication specifications, and enters receiving operation to receive an ID packet transmitted from the remote controller 41 to be connected according to the Bluetooth(R).

The first wireless module 61 includes a rectifier 64 configured to convert AC power to DC power, and an ID discrimination section 65 configured to determine whether or not a signal matches a predetermined ID. When the rectifier 64 receives a wireless signal, it converts the signal to a digital signal and outputs the digital signal to the ID discrimination section 65. If the signal matches the predetermined ID, the ID discrimination section 65 instructs the wireless module 62 to be turned on. In this stage, part or whole of the manipulation target apparatus 42 can be turned on.

In the present second embodiment, the page scan processing by the second wireless module 62 is triggered by a BT module activation indication from the remote controller 41 side being a Bluetooth(R) communication partner. That is, it is ensured that the fourth wireless module 53 performs the page processing. Therefore, while ID packets are periodically received after every certain time period with consideration of low power in a conventional way, the second wireless module 62 continues reception processing operation until the module 62 receives an ID packet without a transmission pause. Thus, it is possible to shorten a time to set the Bluetooth(R) link 44. As a result, a manipulation indication from the remote controller 41 arrives at the manipulation target apparatus 42 faster. That is, the remote controller 41 and the manipulation target apparatus 42 can be made to consume low power, as well as the manipulation target apparatus 42 can respond to a manipulation indication from the remote controller 41 faster.

FIG. 13 shows a processing flow until initiation of communication via the Bluetooth(R) link 44 between the fourth wireless module 53 and the second wireless module 62 configured to be activated as described in the above. In FIG. 13, a portion shown by a dotted line represents that it takes a time for the wireless module 62 to receive an ID packet. As shown in FIG. 13, in setting a wireless link in Bluetooth(R) communication, it is necessary to perform CONNECTION setting processing and CONNECTION disconnection processing before and after a Bluetooth(R) link is in a connected state, which are based on the Bluetooth(R) communication specifications and will not be further described herein.

When the second wireless module 62 in the manipulation target apparatus 42 receives an ID packet transmitted from the fourth wireless module 53 in the remote controller 41, the second wireless module 62 transmits an ID packet meaning a response to the fourth wireless module 53. Then, after proceedings according to a page processing procedure specified in the Bluetooth(R) communication specifications, the Bluetooth(R) link 44 is set between the fourth wireless module 53 and the second wireless module 62, i.e. between the remote controller 41 and the manipulation target apparatus 42. In this case, the fourth wireless module 53, i.e. the remote controller 41 side, is a master, while the second wireless module 62, i.e. the manipulation target apparatus 42 side, is a slave.

After the Bluetooth(R) link 44 is set, the remote controller 41 notifies the manipulation target apparatus 42 of contents of an operation indication. The manipulation target apparatus 42, which receives the contents of operation indication, controls the apparatus so that an apparatus operation control section 63 performs desired operation. When the notification of the contents of operation indication finishes, the Bluetooth(R) link 44 is disconnected.

As an example in that the remote controller 41 uses the Bluetooth(R) communication technique to manipulate the manipulation target apparatus 42, the embodiment has been described in which the remote controller 41 side operates as a master and the manipulation target apparatus 42 side operates as a slave. However, an embodiment is also possible in which the remote controller 41 side operates as a slave and the manipulation target apparatus 42 side operates as a master.

FIG. 14 shows a processing flow until communication is initiated via the Bluetooth(R) link 44 between the wireless module 53 and the wireless module 62 being activated in a reversed master-slave relation as described in the above. In FIG. 14, a portion shown by a dotted line represents that it takes a time for the wireless module 53 to receive an ID packet.

In FIG. 14, when the remote controller 41 accepts an operation indication to a manipulation target apparatus from a user, the operation indication input detection section 51 instructs the fourth wireless module 53 to initiate page scan processing, and the fourth wireless module 53 enters operation to receive an ID packet transmitted from the manipulation target apparatus 42. In addition, the second wireless module 62 activated by the first wireless module 61 which received the BT module activation indication 43 executes a connection creating command, which causes the second wireless module 62 to initiate the page processing in Bluetooth(R) communication and enters operation to transmit an ID packet to the remote controller 41.

When the fourth wireless module 53 in the remote controller 41 receives an ID packet transmitted from the second wireless module 62 in the manipulation target apparatus 42, the fourth wireless module 53 transmits an ID packet meaning a response to the second wireless module 62. Then, after proceedings according to a page processing procedure specified in the Bluetooth(R) communication specifications, the Bluetooth(R) link 44 is set between the fourth wireless module 53 and the second wireless module 62, i.e. between the remote controller 41 and the manipulation target apparatus 42. In this case, the fourth wireless module 53, i.e. the remote controller 41 side, is a slave, while the second wireless module 62, i.e. the manipulation target apparatus 42 side, is a master.

According to the second embodiment, a similar effect can be achieved for Bluetooth(R) communication similarly to the ULP Bluetooth(R) communication in the first embodiment. It can be ensured that a wireless link is established in response to an operation indication such as from a user as well as a time can be shorten to set a Bluetooth(R) link, and a method of setting a wireless link and a wireless system can be realized that reduce power consumption for wireless link setting as much as possible.

### Third Embodiment

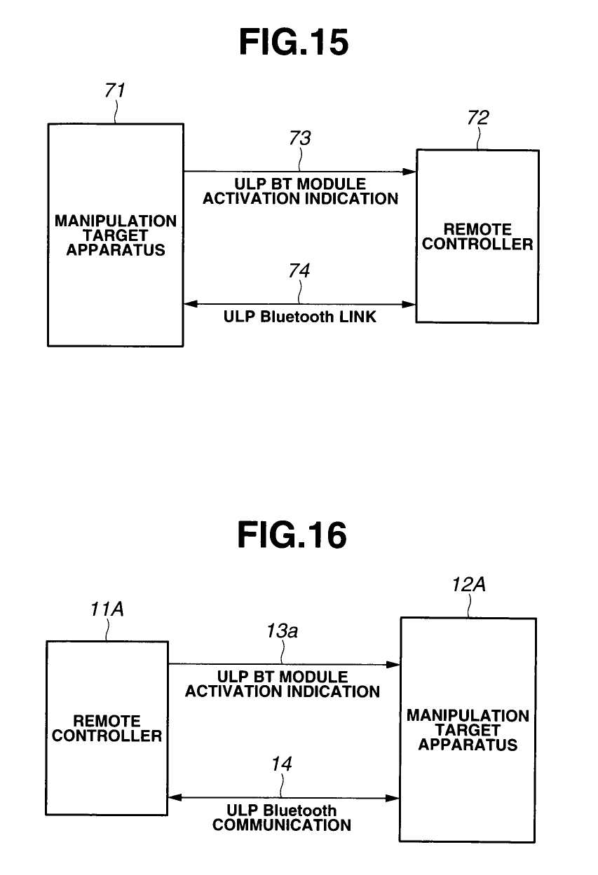

FIG. 15 is a block diagram schematically showing a wireless system according to a third embodiment of the present invention.

In the first embodiment, a wireless module in a manipulation target apparatus is provided with an extremely low-power receiver so that a remote controller gives a ULP BT module activation indication to the manipulation target apparatus based on an operation indication from the outside in ULP Bluetooth(R) communication between two wireless devices. In the present embodiment, a wireless module in a remote controller is provided with an extremely low-power receiver so that a manipulation target apparatus gives a ULP BT module activation indication to a remote controller based on an operation indication from the outside.

As shown in FIG. 15, according to the present embodiment, a manipulation target apparatus 71 can establish the following to a remote controller 72:

(1) communication to instruct ULP Bluetooth(R) communication activation (a ULP BT module activation indication 73 from the manipulation target apparatus 71 to the remote controller 72)

(2) communication to transmit/receive manipulation information (communication via a ULP Bluetooth(R) link 74).

With the above configuration, when a particular manipulation button is pushed on the manipulation target apparatus 71 side, light or sound is outputted from an LED light source or speaker provided on the remote controller 72 via an extremely low-power receiver equipped in the remote controller 72, so that one can soon find the remote controller 72 when one does not know where the controller 72 is.

The use of the third embodiment incorporated in the first embodiment can add value to a wireless system.

According to the third embodiment of the present invention, a wireless system can be added value by taking advantage of the fact that a wireless link can be ensured to be quickly set between two wireless devices.

The first to third embodiments have been described above on an assumption that a remote controller is in a radio wave range for a manipulation target apparatus (i.e., also referred to as an apparatus to be connected to a link).

However, since there is no knowing in advance whether or not a manipulation target apparatus for which the remote controller needs to set a ULP Bluetooth(R) link (also referred to as CONNECTION setting) is positioned in a radio wave range, the remote controller attempts to instruct an apparatus being outside of the radio wave range to activate a ULP BT module if the manipulation target apparatus is not positioned in the radio wave range. As a result, the remote controller consumes unnecessary power.

Further, a remote controller side does not have means for recognizing that a manipulation target apparatus is added or deleted (for example, a TV receiving apparatus is disposed, bought, repaired). As a result, an operator instructs an apparatus that no longer exists to activate a ULP BT module using the remote controller, for example, which results in unnecessary power consumption in the remote controller. For a newly purchased apparatus, the remote controller cannot activate the new apparatus since the remote controller does not have means to acknowledge an ID value of the new apparatus.

### Fourth Embodiment

Next, a fourth embodiment of the present invention will be described with reference to FIGS. 16 to 25.

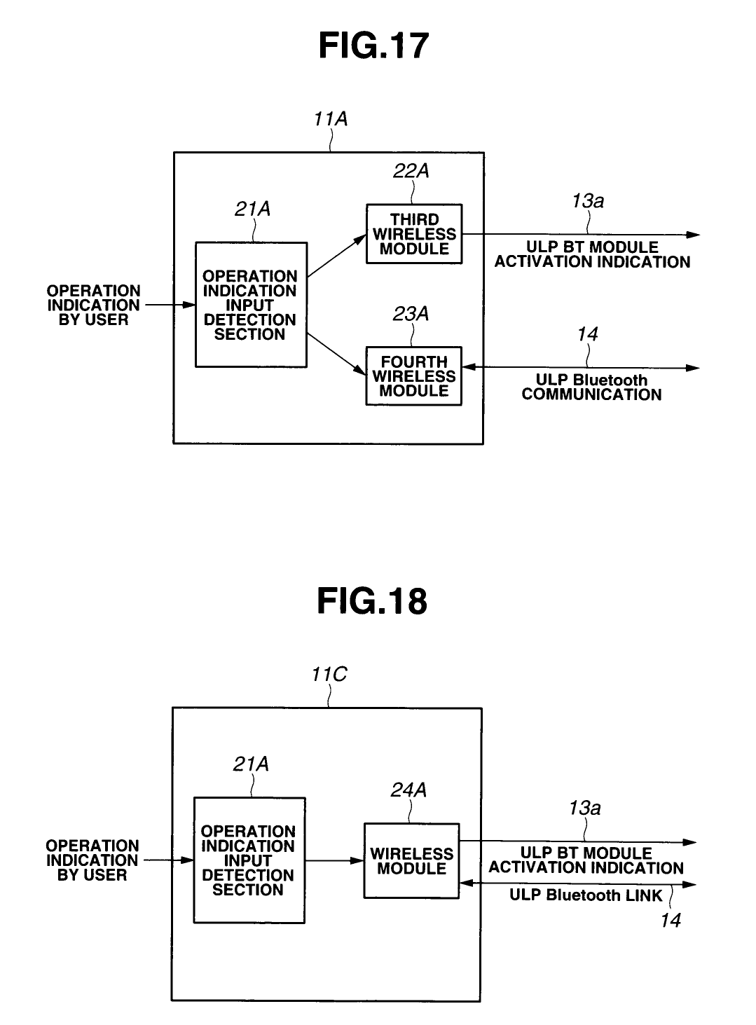

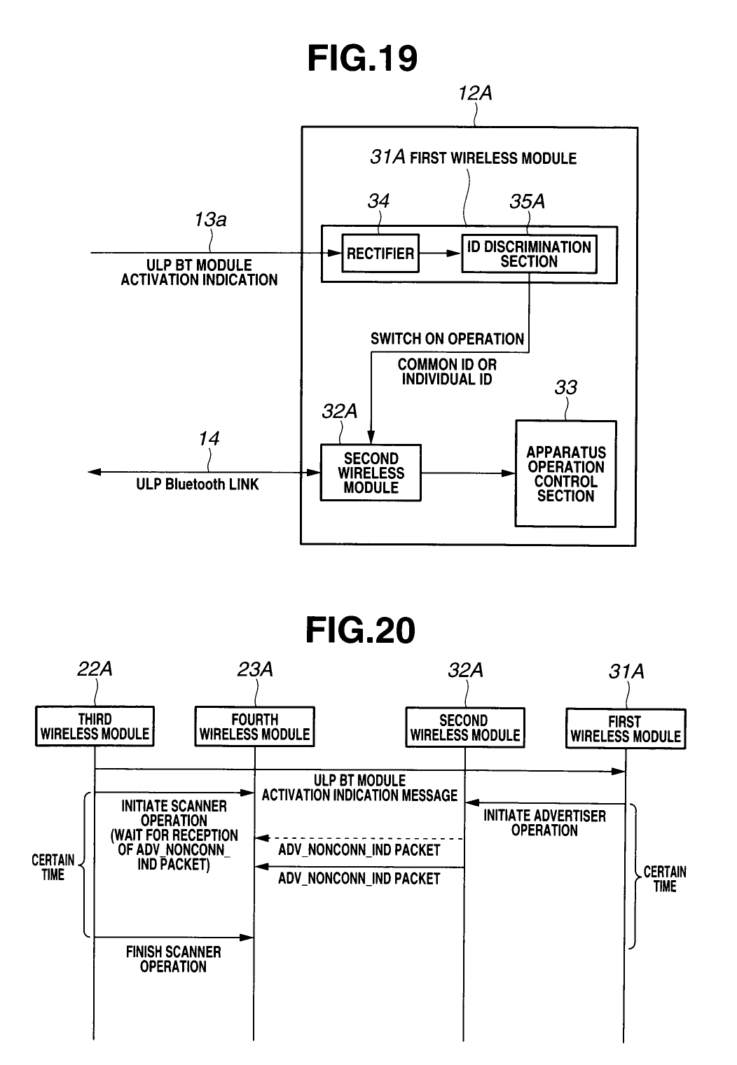

FIG. 16 is a block diagram schematically showing a wireless system according to a fourth embodiment of the present invention. FIG. 17 is a block diagram showing one configuration example of a remote controller as a second wireless device in FIG. 16. FIG. 18 is a block diagram showing another configuration example of the remote controller as the second wireless device in FIG. 16. FIG. 19 is a block diagram showing a configuration example of a manipulation target apparatus as a first wireless device in FIG. 16. The configuration shown in FIGS. 16 to 19 is similar to that shown in FIGS. 1 to 4 in the first embodiment. In the drawings, portions being functionally different from those in FIGS. 1 to 4 are given different reference numerals.

The present embodiment of the present invention includes an embodiment in which a remote controller 11A is used to manipulate a manipulation target apparatus 12A such as a TV receiver, as shown in FIG. 16. In the present embodiment, the remote controller 11A performs with the manipulation target apparatus 12A:

(1) communication to instruct to activate ULP Bluetooth(R) communication (a ULP BT module activation indication 13a)

(2) communication via a ULP Bluetooth(R) communication path 14.

The ULP Bluetooth(R) communication technique herein is a communication technique of integration of the Wibree communication technique known as a low-power consumption wireless communication technique into the well-known Bluetooth(R) specifications. This technique, which is a short-range wireless communication technique using a 2.4 GHz band radio same as the Bluetooth(R) communication technique, can make a longer communication waiting time possible than the Bluetooth(R) communication technique, allowing intermittent transmission and hence lower power consumption. Moreover, the present embodiment provides a technique to surely set a wireless link using a common ID or individual ID with lower-power consumption to a manipulation target apparatus. For the ULP Bluetooth(R) communication technique, a Bluetooth(R) SIG (Special Interest Group) is working for standardization.

FIG. 17 is a block diagram showing configuration of the remote controller 11A. When an operation indication from a user through push-down of a button on the remote controller 11A or speech recognition to the manipulation target apparatus 12A is accepted, the operation indication input detection section 21A as an operation indication detection section instructs a third wireless module 22A to transmit the ULP BT module activation indication 13a containing first information content (common ID) or second information content (individual ID) as a predetermined wireless signal (a ULP BT module activation indication message), and instructs a fourth wireless module 23A to initiate communication via the ULP Bluetooth(R) communication path 14 depending on the first information content or second information content.

In FIG. 17, it is also possible to integrate the third wireless module 22A and the fourth wireless module 23A.

FIG. 18 shows a functional configuration diagram of a remote controller 11C in the above integration.

In FIG. 18, when the operation indication input detection section 21A accepts an operation indication to the manipulation target apparatus 12A from a user through push-down of a button on the remote controller 11C or speech recognition, the section 21A instructs a wireless module 24A to transmit the ULP BT module activation indication 13a containing first information content (common ID) or second information content (individual ID) as a predetermined wireless signal (a ULP BT module activation indication message). Then, the section 21A instructs the wireless module 24A to initiate communication depending on the first information content or second information content via the ULP Bluetooth(R) communication path 14.

Although the remote controller can be configured as shown in FIG. 18, the following description will discuss a case in that the remote controller is configured as shown in FIG. 17.

FIG. 19 shows a block diagram of the manipulation target apparatus 12A.

The fourth embodiment shown in FIG. 19 differs from the first embodiment in that the remote controller 11A as a second wireless device transmits the ULP BT module activation indication 13a being a predetermined wireless signal containing a common ID or individual ID from the third wireless module 22A, the received manipulation target apparatus 12A as the first wireless device discriminates the common ID or individual ID in an ID discrimination section 35A of a first wireless module 31A, and sends out the common ID or individual ID with a power-on signal to a second wireless module 32A. Further, the second wireless module 32A executes operation shown in FIG. 20 or 23 based on the common ID or individual ID, respectively.

The rectifier 34 in the first wireless module 31A can be configured similarly to FIG. 5.

Herein, the second wireless module 32A configured to operate as an advertiser has a function of continuing to transmit any of three types of packet in the following to the fourth wireless module 23A configured to operate as an initiator (see FIG. 17) for a predetermined time in ULP Bluetooth(R) communication:

(1) ADV_IND packets (Advertising Indication packets)

(2) ADV_DIRECT_IND packets (Advertising Directed Indication packets)

(3) ADV_NONCONN_IND packets (Advertising Non-Connectable Indication packets)

As discussed in the above, a payload portion of an ADV_IND packet contains address information specifying an advertiser of a transmission source. Meanwhile, a payload portion of an ADV_DIRECT_IND packet contains, in addition to the address information specifying the advertiser of the transmission source, address information specifying an initiator being a transmission destination of the packet.

If the second wireless module 32A as an advertiser transmits an ADV_IND packet or ADV_DIRECT_IND packet, the advertiser permits a request to set a ULP Bluetooth(R) link by a response packet from another wireless module. However, if the advertiser transmits an ADV_NONCONN_IND packet, the advertiser does not permit setting of a ULP Bluetooth(R) link by the other wireless module. That is, for an ADV_NONCONN_IND packet, proceedings are not performed to set a ULP Bluetooth(R) link, but proceedings are only performed for information notification of an individual ID of the manipulation target apparatus 12A.

A type of a packet transmitted by an advertiser can be specified by using a parameter “Event_Type value” in an advertiser parameter setting command (HCI_ULP_Set Advertising_Parameters command).

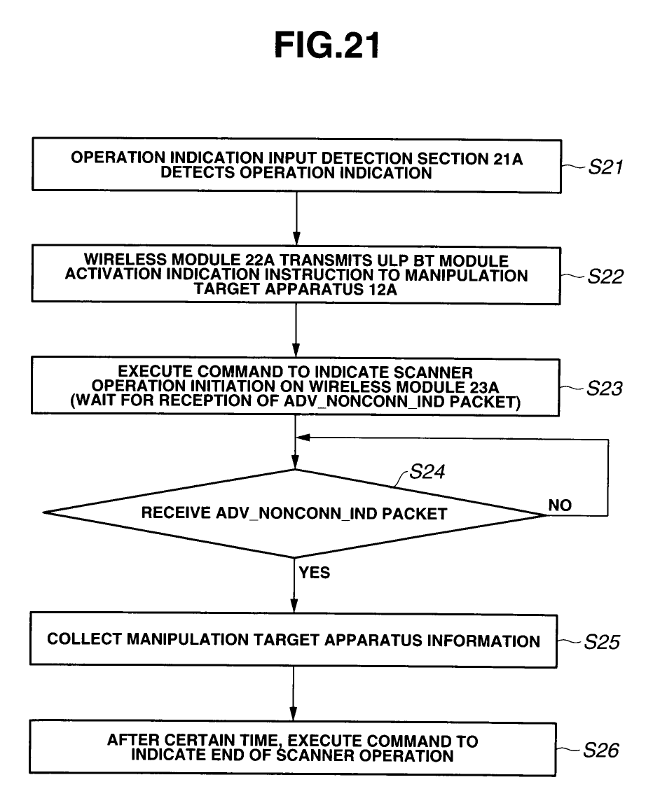

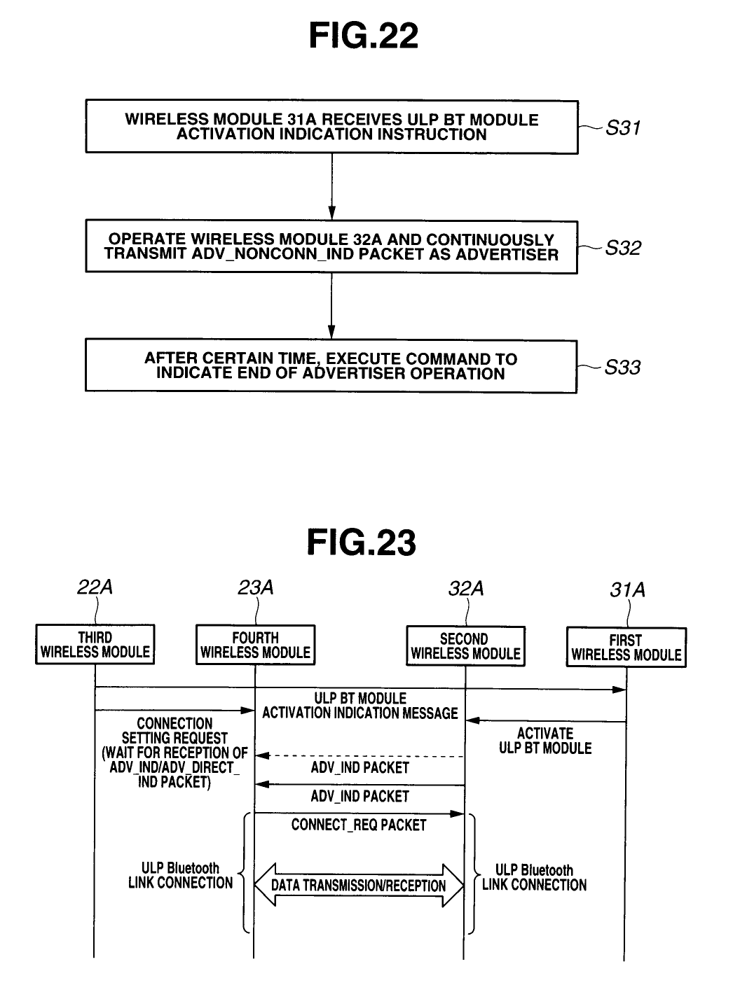

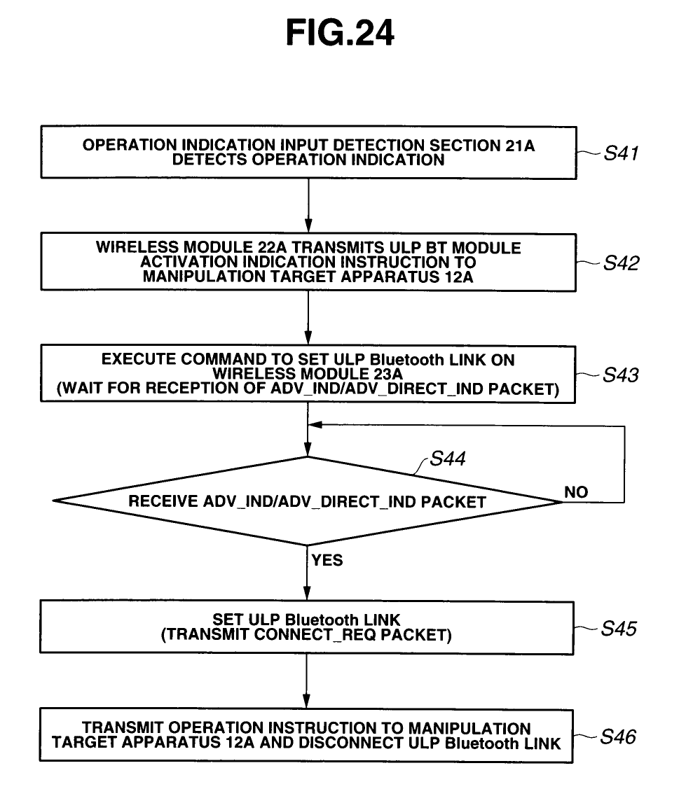

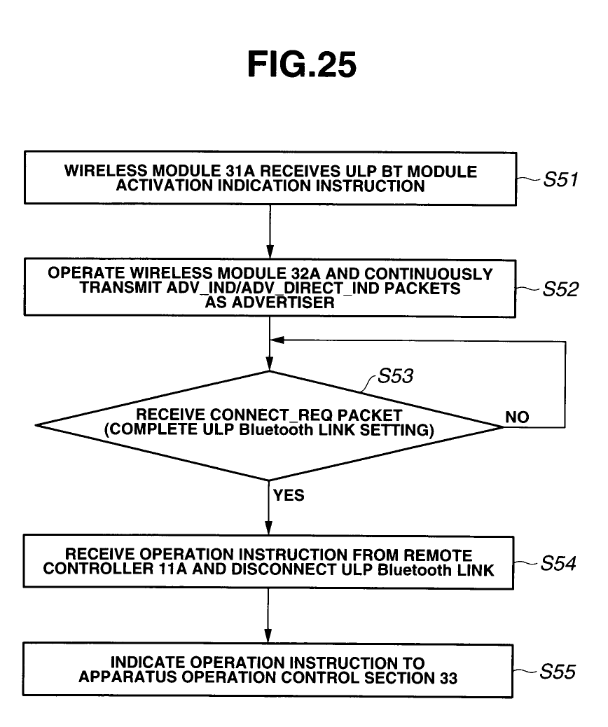

FIG. 20 is a diagram showing a processing flow between a fourth wireless module of a second wireless device and a second wireless module of a first wireless device that are activated with a common ID contained in a wireless signal from the second wireless device to collect manipulation target apparatus information through ULP Bluetooth(R) communication. FIG. 21 is a flowchart illustrating operation by a remote controller side in the processing shown in FIG. 20. FIG. 22 is a flowchart illustrating operation by a manipulation target apparatus 12 side in the processing shown in FIG. 20. FIG. 23 is a diagram showing a processing flow until communication is initiated with a Bluetooth(R) link being established between the second wireless device and the first wireless device. FIG. 24 is a flowchart showing operation by the remote controller side in the processing shown in FIG. 23. FIG. 25 is a flowchart showing operation by the manipulation target apparatus side in the processing shown in FIG. 23.

In the fourth embodiment of the present invention, multiple types (two types, in the drawings) of ID values are defined that can be recognized by the ID discrimination section 35A in the first wireless module 31A. When operation as an advertiser is initiated with operation of the second wireless module 32A being in an on-state, a type of a packet to be transmitted is specified based on an ID value identified by the ID discrimination section 35A. In the third wireless module 22A, the ULP BT module activation indication 13a as a predetermined wireless signal uses different ID values to be notified to the first wireless module 31A based on an application specification of the remote controller 11A, and controls operation as an advertiser in the second wireless module 32A.

Two types of ID values below are specified to be notified to the first wireless module 31A as the ULP BT module activation indication 13a. Every manipulation target apparatus 12A manipulated by the remote controller 11A retains a “common ID value” and an “individual ID value” in the following:

### (1) Common ID Value

As a common ID value, a same value is assigned to all the manipulation target apparatuses. The value is used for the remote controller 11A to obtain an individual ID value retained by a manipulation target apparatus positioned in a radio wave range (discussed later).

As shown in FIG. 20, the ULP BT module activation indication 13a notifies the first wireless module 31A of a common ID value, so that the first wireless module 31A identifies the value in the ID discrimination section 35A, and turns operation of the second wireless module 32A into an on-state to initiate operation as an advertiser. Meanwhile, the second wireless module 32A periodically sends ADV_NONCONN_IND packets for a certain period. Detailed contents of indication by the ID discrimination section 35A to the second wireless module 32A is as follows: first, an advertiser parameter setting command (an HCI_ULP_Set_Advertising_Parameters command) determined in the ULP Bluetooth(R) communication specifications is used to instruct to transmit an ADV_NONCONN_IND packet. Then, an advertise mode write command (HCI_ULP_Write_Advertise_Mode command) determined in the ULP Bluetooth(R) communication specifications is executed on the second wireless module 32A with a parameter “On_or_Off” being “On” to initiate operation as an advertiser. After a predetermined time, an advertise mode write command is executed with the parameter “On_or_Off” being “Off” to finish the operation as an advertiser.

On the other hand, the operation indication input detection section 21A of the remote controller 11A side transmits the ULP BT module activation indication 13a containing a common ID value from the third wireless module 22A, while activating the fourth wireless module 23A to initiate operation to receive an ADV_NONCONN_IND packet (operation as a scanner). Detailed contents of indication by the operation indication input detection section 21A to the fourth wireless module 23A is as follows: a scan mode write command (HCI_ULP_Write_Scan_Mode command) determined in the ULP Bluetooth(R) communication specifications is executed with a parameter “On_or_Off” being “On” to initiate receiving operation as a scanner. After a predetermined time, a scan mode write command is executed with the parameter “On_or_Off” being “Off” to finish the receiving operation as a scanner. In this case, the fourth wireless module 23A performs only operation to receive an ADV_NONCONN_IND packet, but not packet transmitting operation.

A payload portion of an ADV_NONCONN_IND packet is provided with an address field describing address information specifying an advertiser of a transmission source and a data field that can describe data of up to arbitrary 31 octets. In the fourth embodiment of the present invention, the data field describes at least an individual ID value retained by the manipulation target apparatus 12A being a transmission source of an ADV_NONCONN_IND packet. The data field further describes information specifying the manipulation target apparatus 12A, for example information to distinguish an apparatus type (TV, recorder, etc.).

In the above manner, the remote controller 11A, which receives an ADV_NONCONN_IND packet, can previously obtain information of a manipulation target apparatus positioned in a radio wave range. That is, the remote controller 11A can initially get manipulation target apparatus information such as an ID specifying a transmission source through an ADV_NONCONN_IND packet before link connection.

### (2) Individual ID Value

A different individual ID value is assigned to each manipulation target apparatus 12A. An individual ID value is used for the remote controller 11A to set a ULP Bluetooth(R) link to the particular manipulation target apparatus 12A and manipulate the manipulation target apparatus 12A.

As shown in FIG. 23, the ULP BT module activation indication 13a notifies the first wireless module 31A of an individual ID value, so that the first wireless module 31A turns operation of the second wireless module 32A into an on-state and the second wireless module 32A initiates operation as an advertiser. At this time, the second wireless module 32A periodically sends ADV_IND packets or ADV_DIRECT_IND packets for a certain period. Detailed contents of indication to the second wireless module 32A by the ID discrimination section 35A is as follows: first, a advertiser parameter setting command (HCI_ULP_Set_Advertising_Parameters command) determined in the ULP Bluetooth(R) communication specifications is used to instruct to transmit an ADV_IND packet or ADV_DIRECT_IND packet. Then, an advertise mode write command (HCI_ULP_Write_Advertise_Mode command) determined in the ULP Bluetooth(R) communication specifications is executed with a parameter “On_or_Off” being “On” on the second wireless module 32A to initiate operation as an advertiser.

Meanwhile, the operation indication input detection section 21A of the remote controller 11A side transmits the ULP BT module activation indication 13a containing an individual ID value from the third wireless module 22A, and simultaneously activates the fourth wireless module 23A. The remote controller 11A sets a ULP Bluetooth(R) link. As such, detailed contents of indication to the fourth wireless module 23A by the operation indication input detection section 21 is execution of a connection creating command (HCI_ULP_Create_LL_Connection command) determined in the ULP Bluetooth(R) communication specifications. With this execution, the wireless module 23A initiates operation as an initiator in ULP Bluetooth(R) communication, and enters reception waiting operation to receive an ADV_IND packet or ADV_DIRECT_IND packet transmitted from an advertiser including the second wireless module 32A in the manipulation target apparatus 12A.

A payload portion of an ADV_IND packet contains address information specifying an advertiser of a transmission source. On the other hand, a payload portion of an ADV_DIRECT_IND packet contains, in addition to address information specifying an advertiser of a transmission source, address information specifying an initiator being a transmission destination of the packet.

In the present embodiment, the operation as an advertiser by the second wireless module 32A is triggered by a ULP BT module activation indication from the remote controller 11A side being a ULP Bluetooth(R) communication partner. That is, in the present embodiment, it is ensured that the fourth wireless module 23A of the remote controller 11A side operates as a scanner or initiator and is in a reception waiting mode. Therefore, while ADV_IND packets, ADV_DIRECT_IND packets or ADV_NONCONN_IND packets are periodically transmitted after every certain time period with consideration of low power in a conventional way, the second wireless module 32A in the present embodiment continues to transmit ADV_IND packets, ADV_DIRECT_IND packets or ADV_NONCONN_IND packets periodically without a transmission pause. In a command to specify contents of operation as an advertiser (HCI_ULP_Set_Advertise_Parameters command), a period can be specified to transmit ADV_IND packets, ADV_DIRECT_IND packets or ADV_NONCONN_IND packets. In the present embodiment, the command is used to set a parameter for a shortest transmission period (20 ms, in the ULP Bluetooth(R) communication specifications), enabling intermittent transmission of ADV_IND packets, ADV_DIRECT_IND packets or ADV_NONCONN_IND packets without a transmission pause.

In the above manner, if the ULP BT module activation indication 13a notifies a common ID value, it is possible to shorten a time to collect manipulation target apparatus information containing an individual ID value through an ADV_NONCONN_IND packet. Otherwise, if the ULP BT module activation indication 13a notifies an individual ID value, it is possible to shorten a time to set the ULP Bluetooth(R) link 14. As a result, manipulation indication from the remote controller 11A arrives at the manipulation target apparatus 12A faster. That is, the remote controller 11A and the manipulation target apparatus 12 can be made to consume lower power, as well as a response can be made faster to manipulation indication from the remote controller 11A of the manipulation target apparatus 12A.

Additionally, classification of ID values notified through the ULP BT module activation indication 13a into common ID values and individual ID values can prevent manipulation of the remote controller 11A from activating the second wireless module 32A included in a wrong manipulation target apparatus 12A. Previous acquisition of manipulation target apparatus information by notification of common ID values can avoid unnecessary activation of a wireless module, resulting in low-power consumption of the manipulation target apparatus 12A. Further, the remote controller 11A side collects manipulation target apparatus information in advance by notification of a common ID value, so that notification of an individual ID value to the manipulation target apparatus 12 can be prevented, which is not positioned in a radio wave range, resulting in low-power consumption of the remote controller 11A.

FIG. 20 shows a processing flow to collect manipulation target apparatus information through ULP Bluetooth(R) communication between the fourth wireless module 23A of a remote controller side and the second wireless module 32A of a manipulation target apparatus side activated by notification of a common ID as discussed in the above. In FIG. 20, a portion shown by a dotted line represents that it takes a time for the fourth wireless module 23A to receive an ADV_NONCONN_IND packet.

FIG. 21 shows an operation flow of the remote controller 11A side and FIG. 22 shows an operation flow in the manipulation target apparatus 12A side, in the processing shown in FIG. 20.

In FIG. 21, the operation indication input detection section 21 detects an operation indication inputted from the outside (step S21). If the operation indication requests to collect information of the manipulation target apparatus 12A, then the third wireless module 22A transmits an instruction of the ULP BT module activation indication 13a to notify a common ID value to the manipulation target apparatus 12A (step S22). Next, a scan mode write command (HCI_ULP_Write_Scan_Mode command) is executed on the fourth wireless module 23A to initiate operation as a scanner, and the remote controller 11A waits to receive an ADV_NONCONN_IND packet (step S23).

If the ADV_NONCONN_IND packet is received (step S24), then manipulation target apparatus information is collected that is contained in the ADV_NONCONN_IND packet (step S25). After operation as a scanner is executed for a certain time, a scan mode write command (HCI_ULP_Write_Scan_Mode command) is executed to finish the operation as a scanner (step S26).

In FIG. 22, first, the first wireless module 31A receives an instruction of the ULP BT module activation indication 13a (step S31). Notification of a common ID value through the ULP BT module activation indication 13a causes the second wireless module 32A to operate and continuously transmit ADV_NONCONN_IND packets as an advertiser (step S32). After the operation as an advertiser is executed for a certain time, the operation as an advertiser ends (step S33).

FIG. 23 shows a processing flow until initiation of communication via the ULP Bluetooth(R) link 14 between the fourth wireless module 23A and the second wireless module 32A activated by notification of an individual ID as discussed in the above. FIG. 23 is similar to FIG. 6. In FIG. 20, a portion shown by a dotted line represents that it takes a time for the wireless module 23A to receive an ADV_IND packet or ADV_DIRECT_IND packet.

FIG. 24 shows an operation flow of the remote controller 11A side and FIG. 25 shows an operation flow in the manipulation target apparatus 12A side, in the processing shown in FIG. 23. FIGS. 24 and 25 are similar to FIGS. 7 and 8, respectively.

In FIG. 24, the operation indication input detection section 21A detects an operation indication inputted from the outside (step S41). The third wireless module 22A transmits an instruction of the ULP BT module activation indication 13a to the manipulation target apparatus 12A (step S42). Next, a command is executed on the fourth wireless module 23A to set a ULP Bluetooth(R) link (a CONNECTION setting request), and the remote controller 11A waits to receive an ADV_IND packet or ADV_DIRECT_IND packet (step S43).

When an ADV_IND packet or ADV_DIRECT_IND packet is received (step S44), a CONNECT_REQ packet is transmitted to set the ULP Bluetooth(R) link 14 (step S45). Next, an operation instruction is transmitted to the manipulation target apparatus 12, and then the ULP Bluetooth(R) link is disconnected (step S46).

In FIG. 25, first, the first wireless module 31A receives an instruction of the ULP BT module activation indication 13a (step S51). Notification of a common ID value through the ULP BT module activation indication 13a causes the second wireless module 32A to operate and continuously transmit ADV_IND packets or ADV_DIRECT_IND packets as an advertiser (step S52).

Then, a CONNECT_REQ packet is received, which completes setting of the ULP Bluetooth(R) link 14 (step S53). After an operation instruction from the remote controller 11A is received, the ULP Bluetooth(R) link is disconnected (step S54). Next, an operation instruction is made to the apparatus operation control section 33 (step S55).

When the fourth wireless module 23A in the remote controller 11A receives an ADV_IND packet transmitted from the second wireless module 32A in the manipulation target apparatus 12A, the fourth wireless module 23A transmits a CONNECT_REQ packet (Connection Request packet) as a response to the ADV_IND packet to the second wireless module 32A. If the second wireless module 32A can normally receive the CONNECT_REQ packet, then the ULP Bluetooth(R) link 14 is set between the fourth wireless module 23A and the second wireless module 32A, i.e. between the remote controller 11A and the manipulation target apparatus 12A. In this case, the fourth wireless module 23A, i.e. the remote controller 11A side, is a master (connecting side), while the second wireless module 32A, i.e. the manipulation target apparatus 12A side, is a slave (connected side).

After the ULP Bluetooth(R) link 14 is set, the remote controller 11A notifies the manipulation target apparatus 12A of contents of an operation indication. The manipulation target apparatus 12A, which receives the contents of operation indication, controls the apparatus so that the apparatus operation control section 33 performs desired operation. When the notification of the contents of operation indication finishes, the ULP Bluetooth(R) link 14 is disconnected.

In FIG. 23, the second wireless module 32A being an advertiser transmits an ADV_IND packet as a packet to be transmitted. However, instead of broadcasting an ADV_IND packet, a ULP Bluetooth(R) link is set, contents of an operation indication is notified, and the ULP Bluetooth(R) link is disconnected under a similar procedure even if the second wireless module 32A transmits an ADV_DIRECT_IND packet to the fourth wireless module 23A.

According to the fourth embodiment of the present invention, if notification of a common ID value through the ULP BT module activation indication 13a causes a wireless module for ULP Bluetooth(R) communication to operate, a second wireless module operating as an advertiser can transmit an ADV_NONCONN_IND packet only if a fourth wireless module being a connection partner for a ULP Bluetooth(R) link has initiated operation as a scanner, so that unnecessary ADV_NONCONN_IND packet transmission can be prevented. As a result, power consumption of the second wireless module operating as an advertiser can be reduced. Moreover, according to the embodiment of the present invention, the second wireless module operating as an advertiser knows in advance that the fourth wireless module to be notified of an ADV_NONCONN_IND packet has initiated operation as a scanner, hence intermittent transmission of ADV_NONCONN_IND packets that consumes a large amount of power in a conventional use is performed only in necessary periods, preventing consumption of a large amount of power.

Further, if notification of an individual ID value through the ULP BT module activation indication 13a causes a wireless module for ULP Bluetooth(R) communication to operate, the second wireless module operating as an advertiser can transmit an ADV_IND packet or an ADV_DIRECT_IND packet only if the fourth wireless module being a connection partner for a ULP Bluetooth(R) link has initiated operation as an initiator, so that unnecessary ADV_IND packet or ADV_DIRECT_IND packet transmission can be prevented. As a result, power consumption of the second wireless module operating as an advertiser can be reduced. Moreover, according to the embodiment of the present invention, the second wireless module operating as an advertiser knows in advance that the fourth wireless module being a connection partner has initiated the operation as an initiator, hence intermittent transmission of ADV_IND packets or ADV_DIRECT_IND packets that consumes a large amount of power in a conventional use is performed only in necessary periods, preventing consumption of a large amount of power. That is, only in periods that need CONNECTION setting based on an operation indication by a user, a ULP Bluetooth(R) link can be set instantly between the second and fourth wireless modules.

Therefore, it can be ensured that a wireless link is established in response to an operation indication such as from a user, and a method of setting a wireless link and a wireless system can be realized that reduce power consumption for the link establishment as much as possible.

Furthermore, common ID values and individual ID values are defined as ID values that can be notified through the ULP BT module activation indication 13a. Different use of ID values is specified so that proceedings are performed to set a ULP Bluetooth(R) link only in a case of notification of an individual ID value, while the proceedings are not performed to set a ULP Bluetooth(R) link, but proceedings are performed only to notify information of the manipulation target apparatus 12A in a case of notification of a common ID value. This use produce effects below.

Information of the manipulation target apparatus 12A can be collected in advance by notification of a common ID value, so that the remote controller 11 can always acknowledge whether or not a manipulation target apparatus to be connected is positioned in a radio wave range. This can prevent performance of processing to set a ULP Bluetooth(R) link to an apparatus that is not positioned in the radio wave range, hence unnecessary operation can be eliminated, and power consumption can be reduced for the third wireless module 22A and the fourth wireless module 23A in the remote controller 11A side. Further, if a manipulation target apparatus 12A is added or deleted, information of the manipulation target apparatus 12A can be collected in advance by notification of a common ID value. Therefore, the remote controller 11A side can collect information about addition or deletion of the manipulation target apparatus 12A.

In the first to third embodiments, an ID is defined only as an ID of the manipulation target apparatus 12 for the remote controller 11, i.e., an ID of a manipulation target apparatus corresponding to the remote controller.

On the other hand, in the fourth embodiment, in a method of setting a wireless link between devices being connectable via ULP Bluetooth communication (Ultra Low Power Bluetooth communication), a first wireless device is equipped with an extremely low-power receiver (ECO CHIP). An extremely low-power receiver can identify information contained in a received wireless signal. When the receiver receives a wireless signal containing first information content (a common ID) or a wireless signal containing second information content (an individual ID), the first wireless device is turned on and operation of ULP Bluetooth communication as an advertiser is initiated. If a received signal transmitted from the second wireless device and received by the first wireless device contains the first information content (a common ID), content of operation of the first wireless device as an advertiser is: intermittent transmission of ADV_NONCONN_IND packets (Advertising Non-Connectable Indication packets) containing at least the second information content (an individual ID) for a predetermined time. When the second wireless device transmits the common ID to the first wireless device and the first wireless device receives the ID, the first wireless device sends an ADV_NONCONN_IND packet containing an individual ID of the first wireless device, and the second wireless device receives the packet and captures and can register (store) individual IDs of a plurality of first wireless devices in the second wireless device. Meanwhile, if the received signal transmitted from the second wireless device and received by the first wireless device contains the second information content (an individual ID), content of operation of the first wireless device as an advertiser is: the first wireless device continues to send ADV_IND packets (Advertising Indication packets) or ADV_DIRECT_IND packets (Advertising Directed Indication packets) periodically without a transmission pause until reception of a CONNECT_REQ packet (Connection Request packet) transmitted from the second wireless device side. When the second wireless device receives the packets, the CONNECT_REQ packet is transmitted to the first wireless device as a response packet. As a result, a wireless link is established (set) between the first and second wireless devices.

In the above manner, the second wireless device, for example a remote controller, obtains an individual ID from the first wireless device, for example a manipulation target apparatus, by using a first common ID, so that the second wireless device no longer needs to transmit the common ID. Thereafter, only by pushing a key necessary to operate a desired manipulation target apparatus, contents of apparatus operation indication and the individual ID are transmitted so that the manipulation target apparatus can be operated. While such application is possible, transmission of information containing a common ID and transmission of information containing an individual ID can be repeated each time a remote controller is manipulated. With such application, if there are multiple types of manipulation target apparatuses (for example, TV, air conditioner, microwave oven, etc.), it is checked every time whether or not a manipulation target apparatus is in a radio wave range of a remote controller. By this checking, it can be checked which apparatus is operational and judged whether or not to operate a desired manipulation target apparatus.

According to the fourth embodiment of the present invention, a wireless module operating as an advertiser can broadcast a packet only if a wireless module being a communication partner for a ULP Bluetooth(R) link has initiated operation as an initiator or scanner, so that unnecessary packet transmission can be prevented. As a result, power consumption of the second wireless module operating as an advertiser can be reduced. Moreover, according to the fourth embodiment, the wireless module operating as an advertiser knows in advance that the wireless module being a connection partner has initiated the operation as an initiator or scanner, so that intermittent broadcast of packets that consumes a large amount of power in a conventional does not result in consumption of a large amount of power, and instant ULP Bluetooth(R) communication is possible between the wireless modules.

### Fifth Embodiment

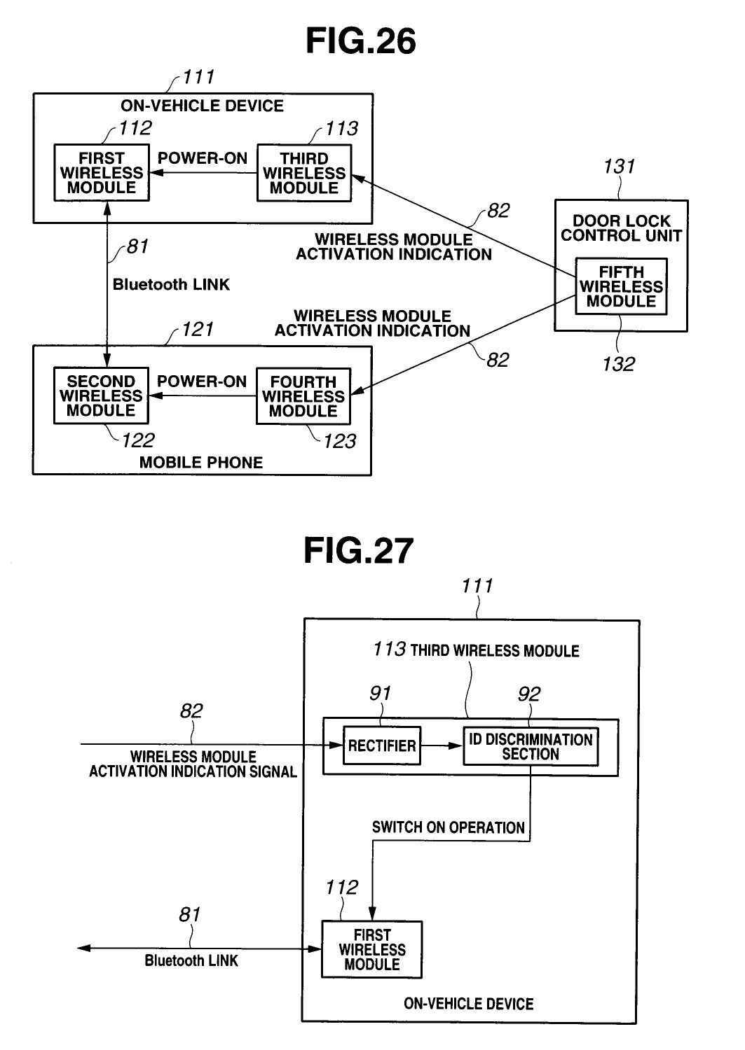

FIG. 26 is a block diagram showing a wireless system according to a fifth embodiment of the present invention. A connection topology is shown for the wireless system in Bluetooth(R) communication according to the second embodiment of the present invention that is applied to an on-vehicle device and a mobile phone. FIG. 27 is a block diagram showing configuration of an on-vehicle device 111 in FIG. 26.

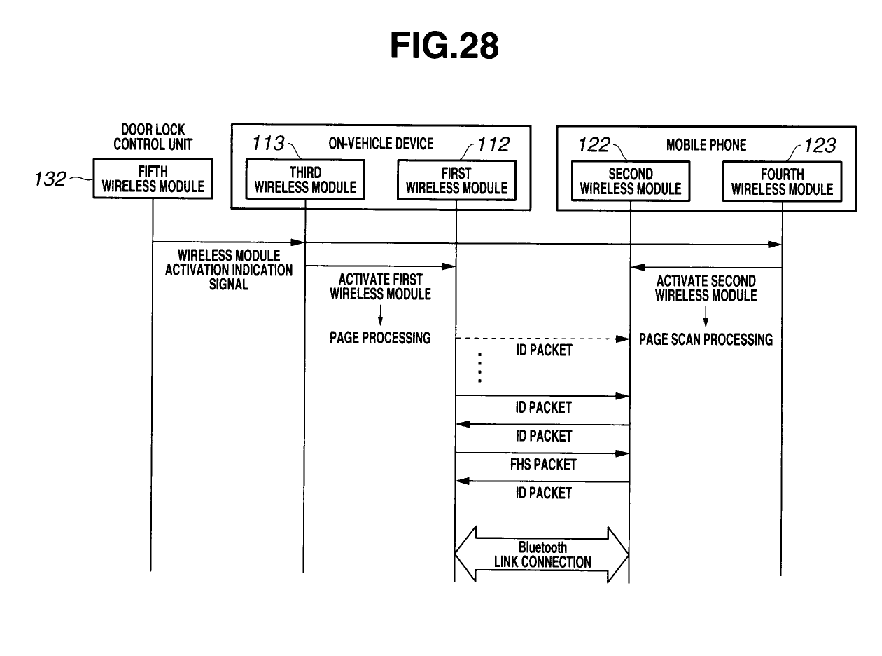

FIG. 28 is a diagram showing an operation flow until the on-vehicle device 111 and a mobile phone 121 in FIG. 26 are automatically connected by Bluetooth(R).

In FIG. 25, a reference numeral 111 denotes an on-vehicle device being a first wireless device, a reference numeral 121 denotes a mobile phone being a second wireless device, and a reference numeral 131 denotes a door lock control unit.

The on-vehicle device 111 is equipped with a first wireless module 112 being capable of Bluetooth(R) communication, and the mobile phone 121 is equipped with a second wireless module 122 being capable of Bluetooth(R) communication. The first wireless module 112 and the second wireless module 122 can be used to set a Bluetooth(R) link 81 between the on-vehicle device 111 and the mobile phone 121.

Meanwhile, the on-vehicle device 111 is equipped with, in addition to the first wireless module 112, a third wireless module 113 that can receive a wireless signal and extract information contained in the received wireless signal. The mobile phone 121 is equipped with, in addition to the second wireless module 122, a fourth wireless module 123 that can receive a wireless signal and extract information contained in the received wireless signal. Only if the information contained in the received wireless signal matches predetermined information (a “wireless module activation indication signal 82” in the present embodiment), the third wireless module 113 turns operation of the first wireless module 112, the operation being normally in an off-state, into an on-state to activate the first wireless module 112. Meanwhile, only if the information contained in the received wireless signal matches predetermined information (the “wireless module activation indication signal 82” in the present embodiment), the fourth wireless module 123 turns operation of the second wireless module 122, the operation being normally in an off-state, into an on-state to activate the second wireless module 122.

The third wireless module 113 receives the wireless module activation indication signal 82. Only if the received wireless module activation indication signal 82 matches information previously determined with the door lock control unit 131, the third wireless module 113 turns operation of the first wireless module 112, the operation being normally in an off-state, into an on-state to activate the first wireless module 112. The first wireless module 112 activated according to a predetermined procedure is capable of Bluetooth(R) communication.

FIG. 27 shows a block diagram of configuration of the on-vehicle device 111 in FIG. 26.

The third wireless module 113 in the on-vehicle device 111 shown in FIG. 27 includes: a rectifier 91 configured to convert AC power containing digital information based on whether or not there is a radio frequency (RF) signal into DC power; and an ID discrimination section 92 configured to determine whether or not a digital signal extracted from the converted DC power matches a predetermined ID. The configuration of the rectifier 91 is similar to the configuration of the rectifier 34 according to the first embodiment in FIG. 5.

When the rectifier 91 receives a wireless signal, the rectifier 91 converts the wireless signal into a digital signal and outputs the digital signal to the ID discrimination section 92.

The ID discrimination section 92 determines whether or not the digital signal outputted from the rectifier 91 matches a predetermined ID (the “wireless module activation indication signal 82” in the present embodiment). If the digital signal matches the predetermined ID, then the ID discriminator 92 instructs the first wireless module 112 to be turned into an on-state. In this stage, part or whole of the on-vehicle device 111 equipped with the first wireless module 112 can be turned on. Configuration of the fourth wireless module 123 (not shown) equipped in the mobile phone 121 is same as the configuration of the third wireless module 113 shown in FIG. 27 except that the second wireless module 122 should be turned on.

The door lock control unit 131 is equipped with a fifth wireless module 132 that can transmit predetermined information to the on-vehicle device 111 and the mobile phone 121. When the fifth wireless module 132 recognizes that a door lock is released, the fifth wireless module 132 broadcasts a wireless module activation indication signal to neighbors. When the third wireless module 113 equipped in the on-vehicle device 111 and the fourth wireless module 123 equipped in the mobile phone 121 receive the wireless module activation indication signal transmitted from the fifth wireless module 132, they turn operation of the first wireless module 112 and the second wireless module 122 into an on-state, respectively, according to the above procedure.

FIG. 28 shows an operation flow until the on-vehicle device 111 and the mobile phone 121 are automatically connected according to the Bluetooth(R) in which the second embodiment of the present invention is applied.

First, when the door lock control unit 131 recognizes that a door lock is released, the fifth wireless module 132 equipped in the door lock control unit 131 broadcasts the wireless module activation indication signal 82. The wireless module activation indication signal 82 preferably arrives to a distance of several meters assuming that a user who retains the mobile phone 121 releases the lock using a key-less entry system.

When the third wireless module 113 being equipped in the on-vehicle device 111 or the fourth wireless module 123 being equipped in the mobile phone 121 receives a wireless module activation indication signal transmitted from the door lock control unit 131, the device 111 or the phone 121 turns operation of the first wireless module 112 being equipped in the device 111 or the second wireless module 122 being equipped in the phone 121 into an on-state. Thereafter, the on-vehicle device 111 and the mobile phone 121 can communicate with each other by the Bluetooth(R).

The on-vehicle device 111 and the mobile phone 121 that are capable of Bluetooth(R) communication enter operation for Bluetooth(R) connection. In detail, the first wireless module 112 equipped in the on-vehicle device 111 initiates Page processing in Bluetooth(R) communication, and initiates processing to transmit an ID packet to the mobile phone 121. The second wireless module 122 equipped in the mobile phone 121 initiates Page Scan processing in Bluetooth(R) communication, and performs reception processing until arrival of an ID packet transmitted from the on-vehicle device 111.

In the present embodiment, the page processing by the first wireless module 112 equipped in the on-vehicle device 111 is triggered by reception of a wireless module activation indication signal from the door lock control unit 131. The page scan processing by the second wireless module 122 equipped in the mobile phone 121 is triggered by reception of the wireless module activation indication signal from the door lock control unit 131. That is, the transmission of the wireless module activation indication signal from the door lock control unit 131 ensures both the first wireless module 112 equipped in the on-vehicle device 111 and the second wireless module 122 equipped in the mobile phone 121 perform operation for Bluetooth(R) connection. Therefore, while ID packets are periodically received after every certain time period with consideration of low power in normal page scan processing, the second wireless module 122 of the mobile phone 121 side continues reception processing operation without a transmission pause until reception of an ID packet. Thus, it is possible to shorten a time to set the Bluetooth(R) link 81. As a result, a Bluetooth(R) service can be quickly provided between the on-vehicle device 111 and the mobile phone 121. That is, the on-vehicle device 111 and the mobile phone 121 can be made to consume lower power, as well as a time to provide a Bluetooth(R) service for the on-vehicle device 111 and the mobile phone 121 can be shorten. Moreover, a user must manipulate only release of the door lock control unit 131, so that the user does not need to manipulate the on-vehicle device 111 and the mobile phone 121 for Bluetooth(R) connection to enjoy a Bluetooth(R) service.

According to the fifth embodiment of the present invention, reception of a wireless module activation indication signal from the door lock control unit initiates both of page processing on an on-vehicle device and page scan processing on a mobile phone. Therefore, while ID packets are periodically received after every certain time period with consideration of low power in normal page scan processing, the mobile phone side can continue processing operation to receive an ID packet transmitted from the on-vehicle device without considering low power and without a transmission pause until reception of the ID packet. Thus, it is possible to shorten a time to set a Bluetooth(R) link. As a result, a Bluetooth(R) service can be quickly provided between the on-vehicle device and the mobile phone.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A wireless system between a first wireless device and a second wireless device, wherein:
the first wireless device comprises a first wireless module having an extremely low-power reception function of receiving an activation indication from the second wireless device and turning on at least the first wireless device based on the indication, and a second wireless module to continue broadcast transmission of a packet periodically without a transmission pause until receiving a response packet from the second wireless device and to establish a link to the second wireless device; and
the second wireless device comprises an operation indication detection section configured to detect an operation indication from outside and to send out an activation indication and a CONNECTION setting request, a third wireless module configured to accept the activation indication from the operation indication detection section and to send out an activation indication message to the first wireless module of the first wireless device, and a fourth wireless module configured to accept the CONNECTION setting request from the operation indication detection section, to wait to receive the packet in the broadcast transmission, and to transmit the response packet to the second wireless module of the first wireless device when receiving the packet in the broadcast transmission.

2. The wireless system according to claim 1, wherein:
the extremely low-power reception function has a function of determining a type of identification information contained in the received activation indication;
the second wireless module has a function of specifying a type of the packet subjected to the broadcast transmission depending on the type of the identification information from the first wireless module, and permitting or not permitting CONNECTION setting to the second wireless device depending on the packet type while continuing the broadcast transmission; and
the fourth wireless module has a function of transmitting or not transmitting the response packet to the second wireless module of the first wireless device depending on the packet type when receiving the packet in the broadcast transmission.

3. The wireless system according to claim 2, wherein:
if the second wireless module of the first wireless device does not permit the CONNECTION setting for the second wireless device, the packet subjected to the broadcast transmission does not request the CONNECTION setting but notifies the second wireless device only of identification information to identify the first wireless device.

4. A wireless communication device comprising:
a first wireless module including an extremely low-power reception function of receiving an activation indication from an external wireless device, and turning on at least the wireless device based on the indication; and
a second wireless module to continue broadcast transmission of a packet periodically without a transmission pause until receiving a response packet from the external wireless device, and to establish a link to the external wireless device.

5. A wireless communication device comprising:
an operation indication detection section configured to detect an operation indication from outside and send out an activation indication and a CONNECTION setting request;
a third wireless module configured to accept the activation indication from the operation indication detection section and send out an activation indication message to a first wireless module of a first wireless device differing from the wireless communication device; and
a fourth wireless module configured to accept the CONNECTION setting request from the operation indication detection section, wait to receive the packet in the broadcast transmission and transmit the response packet to a second wireless module of the first wireless device when receiving the packet in the broadcast transmission.

6. A method of setting a wireless link in a wireless system between a first wireless device and a second wireless device, wherein:
the first wireless device comprising an extremely low-power receiver turns on the first wireless device and continues broadcast transmission of a packet periodically without a transmission pause until reception of a response packet from the second wireless device when the extremely low-power receiver receives a predetermined wireless signal.

7. The method of setting a wireless link according to claim 6, wherein:
the second wireless device transmits a predetermined wireless signal to the extremely low-power receiver equipped in the first wireless device, and enters operation to wait for a packet broadcasted from the first wireless device.

8. The method of setting a wireless link according to claim 6, wherein:
the wireless link being set between the first wireless device and the second wireless device is a wireless link using an Ultra Low Power Bluetooth(R) communication technique (ULP Bluetooth(R) communication technique), and the first wireless device initiates operation as an advertiser in ULP Bluetooth(R) communication when an extremely low-power receiver receives a predetermined wireless signal, and the second wireless device operates as an initiator in ULP Bluetooth(R) communication after transmitting a predetermined wireless signal to the extremely low-power receiver.

9. The method of setting a wireless link according to claim 6, wherein:
the wireless link being set between the first wireless device and the second wireless device is a wireless link using a Bluetooth(R) communication technique, the first wireless device initiates Page Scan operation in Bluetooth(R) communication when an extremely low-power receiver receives a predetermined wireless signal, and the second wireless device transmits the predetermined wireless signal to the extremely low-power receiver, and then initiates Page operation in Bluetooth(R) communication.

10. The method of setting a wireless link according to claim 6, wherein:
the extremely low-power receiver further identifies contents of the received predetermined wireless signal, and specifies a type of the packet subjected to the broadcast transmission based on an identification result.

11. The method of setting a wireless link according to claim 10, wherein:
the second wireless device transmits a predetermined wireless signal to the extremely low-power receiver equipped in the first wireless device, and enters operation to wait for a packet broadcasted from the first wireless device.

12. The method of setting a wireless link according to claim 11, wherein:
the second wireless device differentiates information notified in the wireless signal, and does not perform processing to set connection after reception of the packet broadcasted from the first wireless device for notification of first information, and performs processing to set connection after the reception of the packet broadcasted from the first wireless device for notification of second information.

13. The method of setting a wireless link according to claim 10, wherein:
the wireless link being set between the first wireless device and the second wireless device is a wireless link using an Ultra Low Power Bluetooth(R) communication technique (ULP Bluetooth(R) communication technique), and the first wireless device initiates operation as an advertiser in ULP Bluetooth(R) communication when the extremely low-power receiver receives the predetermined wireless signal, and the second wireless device operates as an initiator or scanner in ULP Bluetooth(R) communication after transmitting a predetermined wireless signal to the extremely low-power receiver.

14. The method of setting a wireless link according to claim 13, wherein:
the first wireless device transmits a packet to permit ULP Bluetooth(R) CONNECTION setting (an ADV_IND packet or ADV_DIRECT_IND packet) in performing operation as an advertiser if the wireless signal received by the extremely low-power receiver contains first information, and transmits a packet (ADV_NONCONN_IND packet) not to permit the ULP Bluetooth(R) CONNECTION setting in performing the operation as an advertiser if the wireless signal received by the extremely low-power receiver contains second information.

15. The method of setting a wireless link according to claim 13, wherein:
the second wireless device performs the operation as an initiator if the wireless signal transmitted to the extremely low-power receiver contains first information, and performs the operation as a scanner if the wireless signal transmitted to the extremely low-power receiver contains second information.

16. The method of setting a wireless link according to claim 6, wherein:
the second wireless device comprising an extremely low-power receiver turns on the second wireless device, and continues processing to receive a packet from the first wireless device periodically without a reception pause until reception of a transmission packet from the first wireless device when the extremely low-power receiver receives a predetermined wireless signal.

17. The method of setting a wireless link according to claim 16, wherein:
the wireless link being set between the first wireless device and the second wireless device is a wireless link using a Bluetooth(R) communication technique, the first wireless device initiates Page operation in Bluetooth(R) communication when the extremely low-power receiver in the first wireless device receives a predetermined wireless signal, and the second wireless device initiates Page Scan operation in Bluetooth(R) communication after the extremely low-power receiver in the second wireless device receives a predetermined wireless signal.

18. A method of setting a wireless link between a first wireless device and a second wireless device in a wireless system, wherein:
the first wireless device being equipped with an extremely low-power receiver turns on the first wireless device and enters operation to wait for a packet transmitted from the second wireless device when the extremely low-power receiver receives a predetermined wireless signal.

19. The method of setting a wireless link according to claim 18, wherein:
the first wireless device enters the operation to wait for a packet without a transmission pause until reception of the packet transmitted from the second wireless device.
